(19) United States
(12) Patent Application Publication
(10) Pub. No.: US 2021/0331586 A1
(43) Pub. Date: Oct. 28, 2021

(54) VEHICLE CONTROL DEVICE AND VEHICLE CONTROL METHOD

(71) Applicant: LG ELECTRONICS INC., Seoul (KR)

(72) Inventors: Hansoo KIM, Seoul (KR); Jaehoon CHO, Seoul (KR); Heejeong HEO, Seoul (KR)

(73) Assignee: LG ELECTRONICS INC., Seoul (KR)

(21) Appl. No.: 16/483,236

(22) PCT Filed: Nov. 30, 2018
(86) PCT No.: PCT/KR2018/015152

§ 371 Date: Aug. 2, 2019

(51) Int. Cl. B60K 35/00; B60R 11/02; H02J 50/80; G06K 9/00

(52) U.S. Cl. CPC B60K 35/00; B60R 11/0241; H02J 50/80; G06K 9/00832; B60K 2370/834; B60K 2370/563; B60K 2370/573; B60K 2370/589; B60K 2370/47

(57) ABSTRACT

Disclosed herein is a control device. The control device includes a communication unit wirelessly exchanging information with a mobile terminal, a cradle installed in a vehicle and including a seating surface and a button formed on the seating surface, a sensing unit sensing an object in contact with the seating surface, and a processor transmitting information on the button to the mobile terminal through the communication unit to control a display unit of the mobile terminal to display a button image corresponding to the button when the mobile terminal is detected through the sensing unit.

### TECHNICAL FIELD

The present invention relates to a vehicle control device and a vehicle control method.

### BACKGROUND ART

Vehicles may be classified as internal combustion engine vehicles, external combustion engine vehicles, gas turbine vehicles, electric vehicles, and the like, according to types of prime movers used therein.

Recently, for the safety and convenience of drivers and pedestrians, smart vehicles have been actively developed and research into sensors to be mounted on the intelligent vehicles have actively been conducted. Cameras, infrared sensors, radars, global positioning systems (GPS), lidars, and gyroscopes are used in intelligent vehicles, among which cameras serve to substitute for human eyes.

Due to development of various sensors and electronic equipment, vehicles equipped with a driving assistance function of assisting an occupant in driving and improving driving safety and convenience has come to prominence.

### DISCLOSURE

### Technical Problem

An embodiment of the present invention provides a control device for assisting driving of a vehicle.

Furthermore, an embodiment of the present invention provides a control device for wirelessly transmitting power to a mobile terminal when the mobile terminal is mounted on a vehicle.

Furthermore, an embodiment of the present invention provides a control device capable of controlling a mobile terminal to display an image button for controlling a vehicle when the mobile terminal is mounted on the vehicle.

Furthermore, an embodiment of the present invention provides a method of assisting driving of a vehicle.

Furthermore, an embodiment of the present invention provides a control method of wirelessly transmitting power to a mobile terminal when the mobile terminal is mounted on a vehicle.

Furthermore, an embodiment of the present invention provides a control method of controlling a mobile terminal to display an image button for controlling a vehicle when the mobile terminal is mounted on the vehicle.

### Technical Solution

Furthermore, in this specification, a control device includes: a communication unit wirelessly exchanging information with a mobile terminal; a cradle installed in a vehicle and including a seating surface and a button formed on the seating surface; a sensing unit sensing an object in contact with the seating surface; and a processor transmitting information on the button to the mobile terminal through the communication unit to control a display unit of the mobile terminal to display a button image corresponding to the button when the mobile terminal is detected through the sensing unit.

The button may turn on or off a control function of the vehicle, and the processor may execute the control function when the mobile terminal is detected through the sensing unit and an execution command of the control function is received through the communication unit.

The processor may deactivate the button when the mobile terminal is detected through the sensing unit.

The cradle may further include a power transmitting unit adjacent to the button and transmitting power wirelessly.

The processor may control the display unit to further display an indicator indicative of a charged amount.

The processor may receive the charged amount of the mobile terminal through the communication unit, and when the charged amount is equal to or greater than a reference value, the processor may receive content of the mobile terminal through the communication unit and control a display inside the vehicle to display the content.

The sensing unit may be installed on the seating surface and include at least one of a contact sensor, a pressure sensor, and a photosensor.

When the mobile terminal is detected through the sensing unit, the processor may control the display unit to display the button image in a first region of the display unit and to display content of the mobile terminal in a second region of the display unit.

When detection of the mobile terminal is stopped after the mobile terminal is detected through the sensing unit, the processor may transmit information on the button to the mobile terminal through the communication unit so that the display unit of the mobile terminal displays a button image corresponding to the button.

The sensing unit may include a camera installed inside the vehicle and imaging the seating surface.

The button may include a first button and a second button, and when the mobile terminal is detected through the camera, the processor may identify the first button covered by the mobile terminal through the camera and transmit information on the first button to the mobile terminal through the communication unit so that the display unit displays a button image corresponding to the first button.

The processor may identify the second button not covered by the mobile terminal through the camera and transmit information on the second button to the mobile terminal through the communication unit so that the display unit displays a button image corresponding to the second button.

The communication unit may wirelessly exchange information with a first mobile terminal and a second mobile terminal, and the button may include a first button and a second button, and when the first mobile terminal and the second mobile terminal in contact with the seating surface are detected through the camera, the processor may identify the first button covered by the first mobile terminal and the second button covered by the second mobile terminal through the camera and control a display unit of the first mobile terminal to display a button image corresponding to the first button through the communication unit and control a display unit of the second mobile terminal to display a button image corresponding to the second button through the communication unit.

The communication unit may wirelessly exchange information with a first mobile terminal and a second mobile terminal, the button may include a first button and a second button, and when the first mobile terminal and the second mobile terminal in contact with the seating surface are detected through the camera, the processor may identify the first button covered by the first mobile terminal and the second button covered by the second mobile terminal through the camera and control a display unit of the first mobile terminal to display a button image corresponding to the first button and a button image corresponding to the second button through the communication unit.

The processor may detect a region which is covered by the mobile terminal and adjacent to the cradle through the camera, and control the display unit of the mobile terminal to display the region through the communication unit.

When a third button is identified in the region through the camera, the processor may control the display unit of the mobile terminal to display a button image corresponding to the third button through the communication unit.

Furthermore, in this specification, a control method includes: sensing a mobile terminal in contact with a seating surface of a cradle inside a vehicle; transmitting, to the mobile terminal, information on a button formed on the seating surface and turning on or off a function of controlling the vehicle when the mobile terminal is detected; receiving an execution command of the function from the mobile terminal; and executing the function when the execution command is received.

The transmitting of information on the button to the mobile terminal may include instructing the mobile terminal so that a display unit of the mobile terminal displays a button image corresponding to the button.

The control method may further include: deactivating the button when the mobile terminal is detected.

The control method may further include: wirelessly transmitting power to the mobile terminal through a power transmitting unit adjacent to the button.

### Advantageous Effects

Effects of the control device according to the present invention are as follows.

According to at least one of the embodiments of the present invention, the control device assisting driving of the vehicle can be provided.

According to at least one of the embodiments of the present invention, the control device for wirelessly transmitting power to a mobile terminal when the mobile terminal is mounted on a vehicle can be provided.

According to at least one embodiment of the present invention, the control device capable of controlling a mobile terminal to display an image button for controlling a vehicle when the mobile terminal is mounted on the vehicle can be provided.

Effects of the control method according to the present invention are as follows.

According to at least one of the embodiments of the present invention, a method of assisting driving of a vehicle can be provided.

According to at least one embodiment of the present invention, the control method of wirelessly transmitting power to a mobile terminal when the mobile terminal is mounted on a vehicle can be provided.

According to at least one of the embodiments of the present invention, the control method of controlling a mobile terminal to display an image button for controlling a vehicle when the mobile terminal is mounted on the vehicle can be provided.

### DESCRIPTION OF DRAWINGS

FIG. 1 shows an appearance of a vehicle including a control device according to an embodiment of the present invention.

FIG. 2 is an example of an internal block diagram of a vehicle.

FIG. 3 is a block diagram of a control device according to an embodiment of the present invention.

FIG. 4 is a plan view of a vehicle including a control device according to an embodiment of the present invention.

FIG. 5 shows an example of a camera according to an embodiment of the present invention.

FIG. 6 is a view showing the inside of a vehicle having a vehicle driving assistance apparatus according to an embodiment of the present invention.

FIG. 7 illustrates a mobile terminal according to an embodiment of the present invention.

FIG. 8 is a block diagram of a mobile terminal according to an embodiment of the present invention.

FIGS. 9 to 29 are views showing a control device according to an embodiment of the present invention.

### MODE FOR INVENTION

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element may be connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

A vehicle as described in this specification may include a vehicle and a motorcycle. Hereinafter, a vehicle will be as an example of a vehicle.

A vehicle as described in this specification may include all of an internal combustion engine vehicle including an engine as a power source, a hybrid vehicle including both an engine and an electric motor as a power source, and an electric vehicle including an electric motor as a power source.

In some implementations, the left of a vehicle means the left of the vehicle in the direction of travel and the right of the vehicle means the right of the vehicle in the direction of travel.

In some implementations, a left hand drive (LHD) vehicle will be assumed unless otherwise stated.

Hereinafter, a user, a driver, an occupant, and a fellow occupant may be mixed according to an embodiment.

In the following description, a control device 100, a separate device provided in a vehicle, executes a vehicle driving assistance function, while exchanging necessary information with the vehicle through data communication. However, an aggregation of some of the units of the vehicle may also be defined as the control device 100. The control device 100 may also be referred to as a vehicle control device 100, a vehicle driving assistance device 100, or a driving assistance device 100.

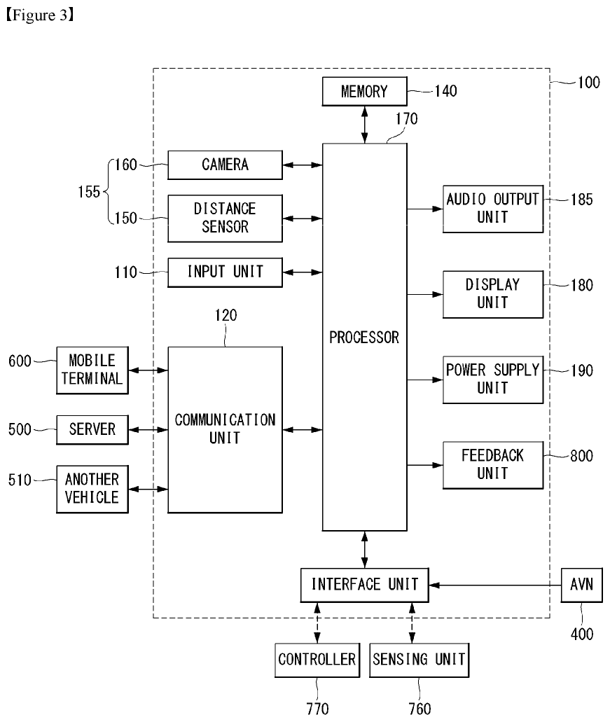

When the control device 100 is a separate device, at least some of the units (see FIG. 3) of the control device 100 may not be included in the control device 100 and may be a unit of the vehicle or another device mounted in the vehicle. The external units may be understood as being included in the control device 100 by transmitting and receiving data through an interface unit of the control device 100.

For the purposes of description, the control device 100 according to an embodiment will be described as directly including the units shown in FIG. 3.

Hereinafter, the control device 100 according to an embodiment will be described in detail with reference to the drawings.

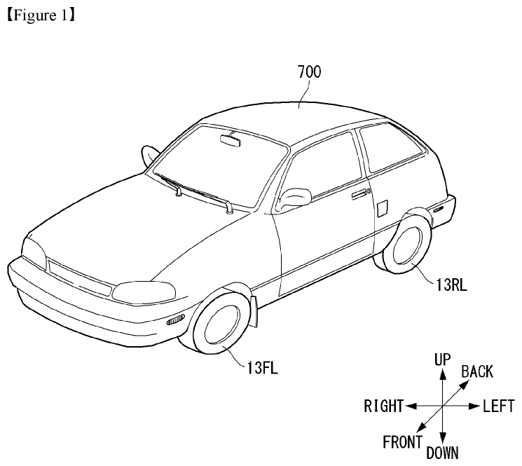

Referring to FIG. 1, a vehicle according to an embodiment may include wheels 13FL and 13RL rotated by a power source and the control device 100 providing driving assistance information to a user.

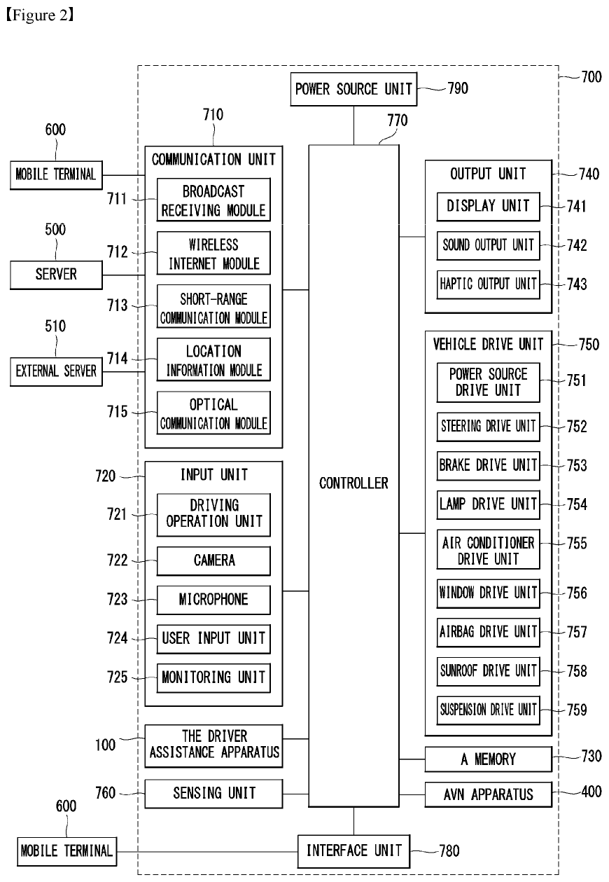

Referring to FIG. 2, the vehicle may include the communication unit 710, the input unit 720, the sensing unit 760, an output unit 740, a vehicle drive unit 750, a memory 730, an interface unit 780, the controller 770, the power source unit 790, the driver assistance apparatus 100, and the AVN apparatus 400. The communication unit 710 may include one or more modules to enable the wireless communication between the vehicle 700 and the mobile terminal 600, between the vehicle 700 and the external server 510, or between the vehicle 700 and another vehicle. In addition, the communication unit 710 may include one or more modules to connect the vehicle 700 to one or more networks.

The communication unit 710 may include a broadcast receiving module 711, a wireless Internet module 712, a short-range communication module 713, a location information module 714, and an optical communication module 715.

The broadcast receiving module 711 is configured to receive a broadcast signal or broadcast associated information from an external broadcast managing server via a broadcast channel. Here, broadcast includes radio broadcast or TV broadcast.

The wireless Internet module 712 is a module for wireless Internet access. The wireless Internet module 712 may be internally or externally coupled to the vehicle 700. The wireless Internet module 712 may transmit or receive wireless signals via communication networks according to wireless Internet technologies.

Examples of such wireless Internet technologies include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), High Speed Uplink Packet Access (HSUPA), Long Term Evolution (LTE), and LTE-A (Long Term Evolution-Advanced). The wireless Internet module 712 may transmit and receive data according to one or more of such wireless Internet technologies, and other Internet technologies as well. For example, the wireless Internet module 712 may exchange data with the external server 510 in a wireless manner. The wireless Internet module 712 may receive weather information and road traffic state information (e.g., Transport Protocol Expert Group (TPEG) information) from the external server 510.

The short-range communication module 713 may assist short-range communication using at least one selected from among Bluetooth™, Radio Frequency IDdentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like.

The short-range communication module 713 forms wireless region networks to perform the short-range communication between the vehicle 700 and at least one external device. For example, the short-range communication module 713 may exchange data with the mobile terminal 600 in a wireless manner. The short-range communication module 713 may receive weather information and road traffic state information (e.g., Transport Protocol Expert Group (TPEG) information) from the mobile terminal 600. When the user gets into the vehicle 700, the mobile terminal 600 of the user and the vehicle 700 may pair with each other automatically or as the user executes a pairing application.

The location information module 714 is a module to acquire a location of the vehicle 700. A representative example of the location information module 714 includes a Global Position System (GPS) module. For example, when the vehicle utilizes a GPS module, a location of the vehicle may be acquired using signals transmitted from GPS satellites.

The optical communication module 715 may include a light emitting unit and a light receiving unit.

The light receiving unit may convert light into electrical signals to receive information. The light receiving unit may include Photo Diodes (PDPs) to receive light. The photo diodes may convert light into electrical signals. For example, the light receiving unit may receive information regarding a preceding vehicle via light emitted from a light source included in the preceding vehicle.

The light emitting unit may include at least one light emitting element to convert electrical signals into light. Here, the light emitting element may be a Light Emitting Diode (LED). The light emitting unit converts electrical signals into light to thereby emit the light. For example, the light emitting unit may externally emit light via flickering of the light emitting element corresponding to a prescribed frequency. In some embodiments, the light emitting unit may include an array of a plurality of light emitting elements. In some embodiments, the light emitting unit may be integrated with a lamp provided in the vehicle 700. For example, the light emitting unit may be at least one selected from among a headlight, a taillight, a brake light, a turn signal light, and a sidelight. For example, the optical communication module 715 may exchange data with another vehicle 520 via optical communication.

The input unit 720 may include a driving operation unit 721, the camera 722, a microphone 723, and the user input unit 724.

The driving operation unit 721 is configured to receive user input for the driving of the vehicle 700. The driving operation unit 721 may include the steering input unit 721a, a shift input unit 721b, an acceleration input unit 721c, and a brake input unit 721d.

The steering input unit 721a is configured to receive user input with regard to the direction of travel of the vehicle 700. The steering input unit 721a may take the form of the steering wheel 12 as illustrated in FIG. 1. In some embodiments, the steering input unit 721a may be configured as a touchscreen, a touch pad, or a button.

The shift input unit 721b is configured to receive input for selecting one of Park (P), Drive (D), Neutral (N) and Reverse (R) gears of the vehicle 700 from the user. The shift input unit 721b may have a lever form. In some embodiments, the shift input unit 721b may be configured as a touchscreen, a touch pad, or a button.

The acceleration input unit 721c is configured to receive user input for the acceleration of the vehicle 700. The brake input unit 721d is configured to receive user input for the speed reduction of the vehicle 700. Each of the acceleration input unit 721c and the brake input unit 721d may have a pedal form. In some embodiments, the acceleration input unit 721c or the brake input unit 721d may be configured as a touchscreen, a touch pad, or a button.

The camera 722 may include an image sensor and an image processing module. The camera 722 may process a still image or a moving image acquired by the image sensor (e.g., a CMOS or a CCD). The image processing module may extract required information by processing a still image or a moving image acquired via the image sensor and, then, may transmit the extracted information to the controller 770. Meanwhile, the vehicle 700 may include the camera 722 to capture a forward image or a surround-view image of the vehicle and an monitoring unit 725 to capture an image of the inside of the vehicle.

The monitoring unit 725 may capture an image of an occupant. The monitoring unit 725 may capture an image of biometrics of the occupant.

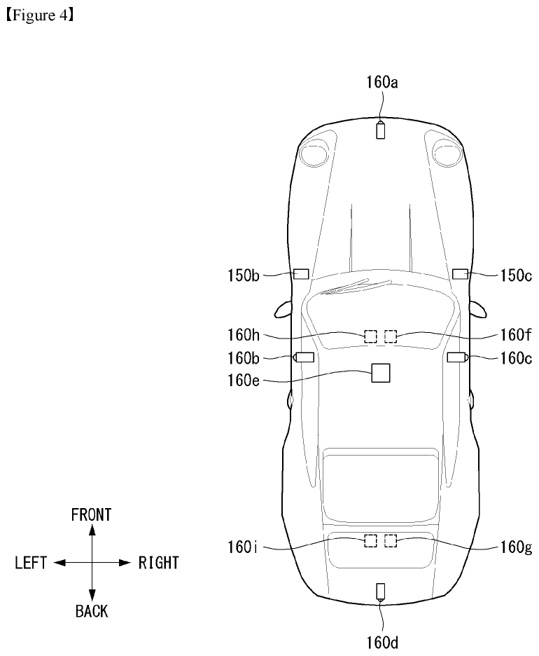

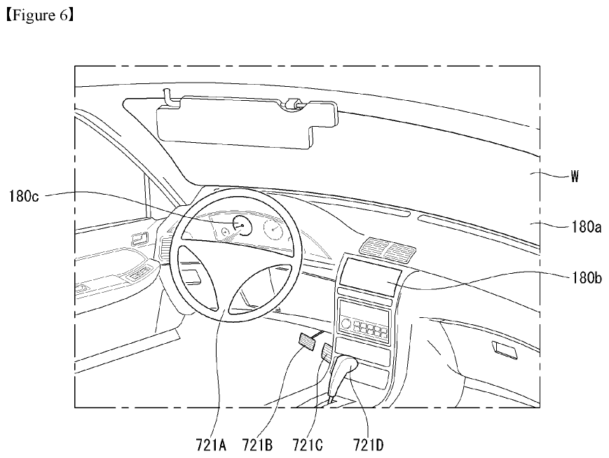

Meanwhile, although FIG. 2 illustrates the camera 722 as being included in the input unit 720, the camera 722 may be described as being a component of the driver assistance apparatus 100 as described above with reference to FIGS. 2 to 6.

The microphone 723 may process external sound signals into electrical data. The processed data may be utilized in various ways according to a function that the vehicle 700 is performing. The microphone 723 may convert a user voice command into electrical data. The converted electrical data may be transmitted to the controller 770.

Meanwhile, in some embodiments, the camera 722 or the microphone 723 may be components of the sensing unit 760, other than components of the input unit 720.

The user input unit 724 is configured to receive information from the user. When information is input via the user input unit 724, the controller 770 may control the operation of the vehicle 700 to correspond to the input information. The user input unit 724 may include a touch input unit or a mechanical input unit. In some embodiments, the user input unit 724 may be located in a region of the steering wheel. In this case, the driver may operate the user input unit 724 with the fingers while gripping the steering wheel.

The sensing unit 760 is configured to detect signals associated with, for example, the traveling of the vehicle 700. To this end, the sensing unit 760 may include a collision sensor, a steering sensor, a speed sensor, gradient sensor, a weight sensor, a heading sensor, a yaw sensor, a gyro sensor, a position module, a vehicle forward/backward movement sensor, a battery sensor, a fuel sensor, a tire sensor, a steering sensor on the basis of the rotation of a steering wheel, a vehicle inside temperature sensor, a vehicle inside humidity sensor, an ultrasonic sensor, an infrared sensor, a radar, and Lidar.

As such, the sensing unit 760 may acquire sensing signals with regard to, for example, vehicle collision information, vehicle traveling direction information, vehicle location information (GPS information), vehicle angle information, vehicle speed information, vehicle acceleration information, vehicle tilt information, vehicle forward/backward movement information, battery information, fuel information, tire information, vehicle lamp information, vehicle inside temperature information, vehicle inside humidity information, and steering wheel rotation angle information. In addition, the driver assistance apparatus 100 that will be described below may generate control signals for acceleration, speed reduction, direction change and the like of the vehicle 700 on the basis of surrounding environment information acquired by at least one of the camera, the ultrasonic sensor, the infrared sensor, the radar, and Lidar included in the vehicle 700. Here, the surrounding environment information may be information related to various objects located within a prescribed distance range from the vehicle 700 that is traveling. For example, the surrounding environment information may include the number of obstacles located within a distance of 100 m from the vehicle 700, the distances to the obstacles, the sizes of the obstacles, the kinds of the obstacles, and the like.

Meanwhile, the sensing unit 760 may further include, for example, an accelerator pedal sensor, a pressure sensor, an engine speed sensor, an Air Flow-rate Sensor (AFS), an Air Temperature Sensor (ATS), a Water Temperature Sensor (WTS), a Throttle Position Sensor (TPS), a Top Dead Center (TDC) sensor, and a Crank Angle Sensor (CAS).

The sensing unit 760 may include a biometric information sensing unit. The biometric information sensing unit is configured to detect and acquire biometric information of the occupant. The biometric information may include fingerprint information, iris-scan information, retina-scan information, hand geometry information, facial recognition information, and voice recognition information. The biometric information sensing unit may include a sensor to detect biometric information of the occupant. Here, the monitoring unit 725 and the microphone 723 may operate as sensors. The biometric information sensing unit may acquire hand geometry information and facial recognition information via the monitoring unit 725.

The output unit 740 is configured to output information processed in the controller 770. The output unit 740 may include the display unit 741, a sound output unit 742, and a haptic output unit 743.

The display unit 741 may display information processed in the controller 770. For example, the display unit 741 may display vehicle associated information. Here, the vehicle associated information may include vehicle control information for the direct control of the vehicle or driver assistance information to guide vehicle driving. In addition, the vehicle associated information may include vehicle state information that notifies a current state of the vehicle or vehicle traveling information regarding the traveling of the vehicle.

The display unit 741 may include at least one selected from among a Liquid Crystal Display (LCD), a Thin Film Transistor LCD (TFT LCD), an Organic Light Emitting Diode (OLED), a flexible display, a 3D display, and an e-ink display.

The display unit 741 may configure an inter-layer structure with a touch sensor, or may be integrally formed with the touch sensor to implement a touchscreen. The touchscreen may function as the user input unit 724 which provides an input interface between the vehicle 700 and the user and also function to provide an output interface between the vehicle 700 and the user. In this case, the display unit 741 may include a touch sensor which senses a touch to the display unit 741 so as to receive a control command in a touch manner.

When a touch is input to the display unit 741 as described above, the touch sensor may detect the touch and the controller 770 may generate a control command corresponding to the touch. Content input in a touch manner may be characters or numbers, or may be, for example, instructions in various modes or menu items that may be designated.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like. Hereinafter, a touch or a touch input may generally refer to various types of touches mentioned above.

Meanwhile, the display unit 741 may include a cluster to allow the driver to check vehicle state information or vehicle traveling information while driving the vehicle. The cluster may be located on a dashboard. In this case, the driver may check information displayed on the cluster while looking forward.

Meanwhile, in some embodiments, the display unit 741 may be implemented as a Head Up display (HUD). When the display unit 741 is implemented as a HUD, information may be output via a transparent display provided at the windshield. Alternatively, the display unit 741 may include a projector module to output information via an image projected to the windshield.

The sound output unit 742 is configured to convert electrical signals from the controller 770 into audio signals and to output the audio signals. To this end, the sound output unit 742 may include, for example, a speaker. The sound output unit 742 may output sound corresponding to the operation of the user input unit 724.

The haptic output unit 743 is configured to generate tactile output. For example, the haptic output unit 743 may operate to vibrate a steering wheel, a safety belt, or a seat so as to allow the user to recognize an output thereof.

The vehicle drive unit 750 may control the operation of various devices of the vehicle. The vehicle drive unit 750 may include at least one of a power source drive unit 751, a steering drive unit 752, a brake drive unit 753, a lamp drive unit 754, an air conditioner drive unit 755, a window drive unit 756, an airbag drive unit 757, a sunroof drive unit 758, and a suspension drive unit 759.

The power source drive unit 751 may perform electronic control for a power source inside the vehicle 700. The power source drive unit 751 may include an acceleration device to increase the speed of the vehicle 700 and a speed reduction device to reduce the speed of the vehicle 700.

For example, in the case where a fossil fuel based engine (not illustrated) is a power source, the power source drive unit 751 may perform electronic control for the engine. As such, the power source drive unit 751 may control, for example, an output torque of the engine. In the case where the power source drive unit 751 is the engine, the power source drive unit 751 may control the speed of the vehicle by controlling the output torque of the engine under the control of the controller 770.

In another example, when an electric motor (not illustrated) is a power source, the power source drive unit 751 may perform control for the motor. As such, the power source drive unit 751 may control, for example, the RPM and torque of the motor.

The steering drive unit 752 may include a steering apparatus. Thus, the steering drive unit 752 may perform electronic control for a steering apparatus inside the vehicle 700.

The brake drive unit 753 may perform electronic control of a brake apparatus (not illustrated) inside the vehicle 700. For example, the brake drive unit 753 may reduce the speed of the vehicle 700 by controlling the operation of brakes located at wheels. In another example, the brake drive unit 753 may adjust the direction of travel of the vehicle 700 leftward or rightward by differentiating the operation of respective brakes located at left and right wheels.

The lamp drive unit 754 may turn at least one lamp arranged inside and outside the vehicle 700 on or off. The lamp drive unit 754 may include a lighting apparatus. In addition, the lamp drive unit 754 may control, for example, the intensity and direction of light of each lamp included in the lighting apparatus. For example, the lamp drive unit 754 may perform control for a turn signal lamp, a headlamp or a brake lamp.

The air conditioner drive unit 755 may perform the electronic control of an air conditioner (not illustrated) inside the vehicle 700. For example, when the inside temperature of the vehicle 700 is high, the air conditioner drive unit 755 may operate the air conditioner to supply cold air to the inside of the vehicle 700.

The window drive unit 756 may perform the electronic control of a window apparatus inside the vehicle 700. For example, the window drive unit 756 may control the opening or closing of left and right windows of the vehicle 700.

The airbag drive unit 757 may perform the electronic control of an airbag apparatus inside the vehicle 700. For example, the airbag drive unit 757 may control an airbag to be deployed in a dangerous situation.

The sunroof drive unit 758 may perform electronic control of a sunroof apparatus inside the vehicle 700. For example, the sunroof drive unit 758 may control the opening or closing of a sunroof.

The suspension drive unit 759 may perform electronic control on a suspension apparatus (not shown). For example, when a road surface has a curve, the suspension drive unit 759 may control the suspension apparatus to reduce vibrations of a vehicle.

The memory 730 is electrically connected to the controller 770. The memory 730 may store basic data for each unit, control data for the operation control of the unit, and input/output data. The memory 730 may be various hardware storage devices such as, for example, a ROM, a RAM, an EPROM, a flash drive, and a hard drive. The memory 730 may store various data for the overall operation of the vehicle 700 such as, for example programs for the processing or control of the controller 770.

The interface unit 780 may serve as a passage for various kinds of external devices that are connected to the vehicle 700. For example, the interface unit 780 may have a port that is connectable to the mobile terminal 600 and may be connected to the mobile terminal 600 via the port. In this case, the interface unit 780 may exchange data with the mobile terminal 600.

Meanwhile, the interface unit 780 may serve as a passage for the supply of electrical energy to the connected mobile terminal 600. When the mobile terminal 600 is electrically connected to the interface unit 780, the interface unit 780 supplies electrical energy from the power source unit 790 to the mobile terminal 600 under the control of the controller 770.

The controller 770 may control the overall operation of each unit inside the vehicle 700. The controller 770 may be referred to as an Electronic Controller (ECU).

The controller 770 may execute a function corresponding to an execution signal delivered from the control device 100.

The controller 770 may be implemented in a hardware manner using at least one selected from among Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, and electric units for the implementation of other functions.

The controller 770 may play the role of the processor 170 described above. That is, the processor 170 of the control device 100 may directly set in the controller 770 of the vehicle. In this embodiment, the control device 100 may be understood to designate a combination of some components of the vehicle.

Further, the controller 770 may control components to transmit information requested by the processor 170.

The power source unit 790 may supply power required to operate the respective components under the control of the controller 770. In particular, the power source unit 790 may receive power from, for example, a battery (not illustrated) inside the vehicle 700.

The AVN apparatus 400 may exchange data with the controller 770. The controller 770 may receive navigation information from the AVN apparatus 400 or a separate navigation apparatus (not illustrated). Here, the navigation information may include set destination information, destination based routing information, and map information or vehicle location information related to vehicle traveling.

Referring to FIG. 3, the vehicle control device 100 may include an input unit 110, a communication unit 120, an interface 130, a sensor unit 155, a monitoring unit 165, a processor 170, a display unit 180, an audio output unit 185, and a power supply unit 190. However, the units of the vehicle control device 100 of FIG. 3 are unnecessary to realize the vehicle control device 100. Thus, the vehicle control device 100 described in this specification may include additional components in addition to the above-described components, or a portion of the above-described components may be omitted.

Each component will now be described in detail. The vehicle control device 100 may include the input unit 110 for receiving user input.

For example, a user may input setting/execution of the vehicle surrounding image display function and the self-driving function, which are provided by the vehicle control device 100, or may input execution of power on/off of the vehicle control device 100 through the input unit 110.

The input unit 110 may include at least one of a gesture input unit (e.g., an photosensor, etc.) for sensing a user gesture, a touch input unit (e.g., a touch sensor, a touch key, a push key (mechanical key), etc.) for sensing touch and a microphone for sensing voice input and receive user input.

Next, the vehicle control device 100 may include the communication unit 120 for communicating with another vehicle 510, a terminal 600 and a server 500.

The communication unit 120 may receive changed information in outer appearance of the vehicle or vehicle surrounding information from an object mounted on the outside of the vehicle or a structure for mounting the object. Also, the vehicle control device 100 may display the vehicle surrounding image on the basis of the changed information in outer appearance of the vehicle and the vehicle surrounding information and provide the self-driving function.

In detail, the communication unit 120 may receive at least one of position information, weather information and road traffic condition information (e.g., transport protocol experts group (TPEG), etc.) from the mobile terminal 600 and/or the server 500.

The communication unit 120 may receive traffic information from the server 500 having an intelligent traffic system (ITS). Here, the traffic information may include traffic signal information, lane information, vehicle surrounding information or position information.

In addition, the communication unit 120 may receive navigation information from the server 500 and/or the mobile terminal 600. Here, the navigation information may include at least one of map information related to vehicle driving, lane information, vehicle position information, set destination information and route information according to the destination.

For example, the communication unit 120 may receive the real-time position of the vehicle as the navigation information. In detail, the communication unit 120 may include a global positioning system (GPS) module and/or a Wi-Fi (Wireless Fidelity) module and acquire the position of the vehicle.

In addition, the communication unit 120 may receive driving information of the other vehicle 510 from the other vehicle 510 and transmit information on this vehicle, thereby sharing driving information between vehicles. Here, the shared driving information may include vehicle traveling direction information, position information, vehicle speed information, acceleration information, moving route information, forward/reverse information, adjacent vehicle information and turn signal information.

In addition, when a user rides in the vehicle, the mobile terminal 600 of the user and the vehicle control device 100 may pair with each other automatically or by executing a user application.

The communication unit 120 may exchange data with the other vehicle 510, the mobile terminal 600 or the server 500 in a wireless manner.

In detail, the communication unit 120 may perform wireless communication using a wireless data communication method. As the wireless data communication method, technical standards or communication methods for mobile communications (for example, Global System for Mobile Communication (GSM), Code Division Multiple Access (CDMA), CDMA2000 (Code Division Multiple Access 2000), EV-DO (Evolution-Data Optimized), Wideband CDMA (WCDMA), High Speed Downlink Packet Access (HSDPA), HSUPA (High Speed Uplink Packet Access), Long Term Evolution (LTE), LTE-A (Long Term Evolution-Advanced), and the like) may be used.

The communication unit 120 is configured to facilitate wireless Internet technology. Examples of such wireless Internet technology include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), and the like.

In addition, the communication unit 120 is configured to facilitate short-range communication. For example, short-range communication may be supported using at least one of Bluetooth™, Radio Frequency IDentification (RFID), Infrared Data Association (IrDA), Ultra-Wideband (UWB), ZigBee, Near Field Communication (NFC), Wireless-Fidelity (Wi-Fi), Wi-Fi Direct, Wireless USB (Wireless Universal Serial Bus), and the like.

In addition, the vehicle control device 100 may pair with the mobile terminal located inside the vehicle using a short-range communication method and wirelessly exchange data with the other vehicle 510 or the server 500 using a long-distance wireless communication module of the mobile terminal.

Next, the vehicle control device 100 may include the interface 130 for receiving data of the vehicle and transmitting a signal processed or generated by the processor 170.

In detail, the vehicle control device 100 may receive at least one of driving information of another vehicle, navigation information and sensor information via the interface 130.

In addition, the vehicle control device 100 may transmit a control signal for executing a driving assistance function or information generated by the vehicle control device 100 to the controller 770 of the vehicle via the interface 130.

To this end, the interface 130 may perform data communication with at least one of the controller 770 of the vehicle, an audio-video-navigation (AVN) apparatus 400 and the sensing unit 760 using a wired or wireless communication method.

In detail, the interface 130 may receive navigation information by data communication with the controller 770, the AVN apparatus 400 and/or a separate navigation apparatus.

In addition, the interface 130 may receive sensor information from the controller 770 or the sensing unit 760.

Here, the sensor information may include at least one of vehicle traveling direction information, vehicle position information, vehicle speed information, acceleration information, vehicle tilt information, forward/reverse information, fuel information, information on a distance from a preceding/rear vehicle, information on a distance between a vehicle and a lane and turn signal information, etc.

The sensor information may be acquired from a heading sensor, a yaw sensor, a gyro sensor, a position module, a vehicle forward/reverse sensor, a wheel sensor, a vehicle speed sensor, a vehicle tilt sensor, a battery sensor, a fuel sensor, a tire sensor, a steering sensor on the basis of rotation of the steering wheel, a vehicle inside temperature sensor, a vehicle inside humidity sensor, a door sensor, etc. The position module may include a GPS module for receiving GPS information.

The interface 130 may receive user input via the user input unit 110 of the vehicle. The interface 130 may receive user input from the input unit of the vehicle or via the controller 770. That is, when the input unit is provided in the vehicle, user input may be received via the interface 130.

In addition, the interface 130 may receive traffic information acquired from the server. The server 500 may be located at a traffic control surveillance center for controlling traffic. For example, when traffic information is received from the server 500 via the communication unit 120 of the vehicle, the interface 130 may receive traffic information from the controller 770.

Next, the memory 140 may store a variety of data for overall operation of the vehicle control device 100, such as a program for processing or control of the controller 170.

In addition, the memory 140 may store data and commands for operation of the vehicle control device 100 and a plurality of application programs or applications executed in the vehicle control device 100. At least some of such application programs may be downloaded from an external server through wireless communication. At least one of such application programs may be installed in the vehicle control device 100 upon release, in order to provide the basic function (e.g., the driver assistance information guide function) of the vehicle control device 100.

Such application programs may be stored in the memory 140 and may be executed to perform operation (or function) of the vehicle control device 100 by the processor 170.

The memory 140 may store data for checking an object included in an image. For example, the memory 140 may store data for checking a predetermined object using a predetermined algorithm when the predetermined object is detected from an image of the vicinity of the vehicle acquired through the camera 160.

For example, the memory 140 may store data for checking the object using the predetermined algorithm when the predetermined algorithm such as a lane, a traffic sign, a two-wheeled vehicle and a pedestrian is included in an image acquired through the camera 160.

The memory 140 may be implemented in a hardware manner using at least one selected from among a flash memory, a hard disk, a solid state drive (SSD), a silicon disk drive (SDD), a micro multimedia card micro type, a card type memory (e.g., an SD or XD memory, etc.), a random access memory (RAM), a static random access memory (SRAM), a read-only memory (ROM), an electrically erasable programmable read-only memory (EEPROM), a programmable read-only memory (PROM), a magnetic memory, a magnetic disk and an optical disc.

In addition, the vehicle control device 100 may operate in association with a network storage for performing a storage function of the memory 140 over the Internet.

Next, the monitoring unit 165 may acquire information on the internal state of the vehicle.

The information detected by the monitoring unit may include at least one of facial recognition information, fingerprint information, iris-scan information, retina-scan information, hand geo-metry information, and voice recognition information. The monitoring unit may include other sensors for sensing such biometric recognition information.

Next, the vehicle control device 100 may further include the sensor unit 155 for sensing objects located in the vicinity of the vehicle. The vehicle control device 100 may include the sensor unit 155 for sensing peripheral objects and may receive the sensor information obtained by the sensor unit 155 of the vehicle via the interface 130. The acquired sensor information may be included in the information on the vehicle surrounding information.

The sensor unit 155 may include at least one of a distance sensor 150 for sensing the position of an object located in the vicinity of the vehicle and a camera 160 for capturing the image of the vicinity of the vehicle.

First, the distance sensor 150 may accurately detect the position of the object located in the vicinity of the vehicle, a distance between the object and the vehicle, a movement direction of the object, etc. The distance sensor 150 may continuously measure the position of the sensed object to accurately detect change in positional relationship with the vehicle.

The distance sensor 150 may detect the object located in at least one of the front, rear, left and right areas of the vehicle. The distance sensor 150 may be provided at various positions of the vehicle.

FIG. 3 illustrates an example exterior of a vehicle including an example vehicle control device. Referring to FIG. 3, the distance sensor 150 may be provided at at least one of the front, rear, left and right sides and ceiling of the vehicle.

The distance sensor 150 may include at least one of various distance measurement sensors such as a Lidar sensor, a laser sensor, an ultrasonic wave sensor and a stereo camera.

For example, the distance sensor 150 is a laser sensor and may accurately measure a positional relationship between the vehicle and the object using a time-of-flight (TOF) and/or a phase-shift method according to a laser signal modulation method.

Information on the object may be acquired by analyzing the image captured by the camera 160 at the processor 170.

In detail, the vehicle control device 100 may capture the image of the vicinity of the vehicle using the camera 160, analyze the image of the vicinity of the vehicle using the processor 170, detect the object located in the vicinity of the vehicle, determine the attributes of the object and generate sensor information.

The image information is at least one of the type of the object, traffic signal information indicated by the object, the distance between the object and the vehicle and the position of the object and may be included in the sensor information.

In detail, the processor 170 may detect the object from the captured image via image processing, track the object, measure the distance from the object, and check the object to analyze the object, thereby generating image information.

The camera 160 may be provided at various positions.

In detail, the camera 160 may include an internal camera 160f for capturing an image of the front side of the vehicle within the vehicle and acquiring a front image.

Referring to FIG. 3, a plurality of cameras 160 may be provided at least one of the front, rear, right and left and ceiling of the vehicle.

In detail, the left camera 160b may be provided inside a case surrounding a left side view mirror. Alternatively, the left camera 160b may be provided outside the case surrounding the left side view mirror. Alternatively, the left camera 160b may be provided in one of a left front door, a left rear door or an outer region of a left fender.

The right camera 160c may be provided inside a case surrounding a right side view mirror. Alternatively, the right camera 160c may be provided outside the case surrounding the right side view mirror. Alternatively, the right camera 160c may be provided in one of a right front door, a right rear door or an outer region of a right fender.

In addition, the rear camera 160d may be provided in the vicinity of a rear license plate or a trunk switch. The front camera 160a may be provided in the vicinity of an emblem or a radiator grill.

The processor 170 may synthesize images captured in all directions and provide an around view image viewed from the top of the vehicle. Upon generating the around view image, boundary portions between the image regions occur. Such boundary portions may be subjected to image blending for natural display.

In addition, the ceiling camera 160e may be provided on the ceiling of the vehicle to capture the image of the vehicle in all directions.

The camera 160 may directly include an image sensor and an image processing module. The camera 160 may process a still image or a moving image obtained by the image sensor (e.g., CMOS or CCD). In addition, the image processing module processes the still image or the moving image acquired through the image sensor, extracts necessary image information, and delivers the extracted image information to the processor 170.

In order to enable the processor 170 to more easily perform object analysis, for example, the camera 160 may be a stereo camera for capturing an image and, at the same time, measuring a distance from an object.

The sensor unit 155 may be a stereo camera including the distance sensor 150 and the camera 160. That is, the stereo camera may acquire an image and, at the same time, detect a positional relationship with the object.

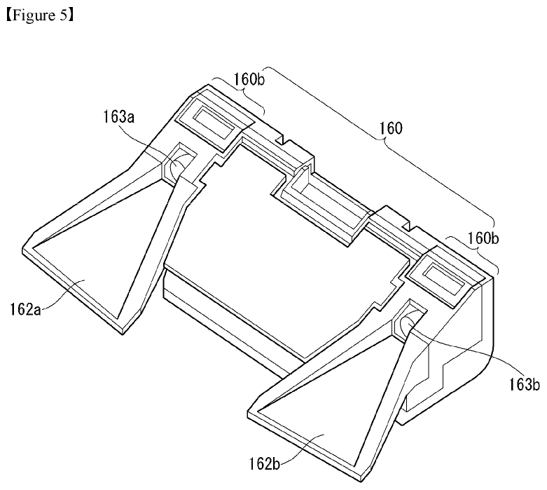

Referring to FIG. 5, the stereo camera 160 may include a first camera 160a having a first lens 163a and a second camera 160b having a second lens 163b.

Meanwhile, the vehicle driving assistance apparatus may further includes a first light shield 162a and a second light shield 162b for shielding light incident on the first lens 163a and the second lens 163b, respectively.

This vehicle driving assistance apparatus may obtain a stereo image of the surroundings of the vehicle from the first and second cameras 160a and 160b, perform disparity detection on the basis of the stereo image, detect an object from at least one stereo image on the basis of disparity information, and continue to track movement of the object after the object is detected.

Next, the control device 100 may further include a display unit 180 displaying a graphic image. The display unit 180 may include a plurality of displays. In detail, the display unit 180 may include a first display 180a for projecting and displaying a graphic image onto and on a vehicle windshield W. That is, the first display 180a is a head up display (HUD) and may include a projection module for projecting the graphic image onto the windshield W. The graphic image projected by the projection module may have predetermined transparency. Accordingly, a user may simultaneously view the front and rear sides of the graphic image.

The graphic image may overlap the image projected onto the windshield W to achieve augmented reality (AR).

The display unit may include a second display 180b separately provided inside the vehicle to display an image of the driving assistance function.

In detail, the second display 180b may be a display of a vehicle navigation apparatus or a center information display (CID). The third display 180c may be a cluster.

The second display 180b may include at least one selected from among a Liquid Crystal Display (LCD), a Thin Film Transistor LCD (TFT LCD), an Organic Light Emitting Diode (OLED), a flexible display, a 3D display, and an e-ink display.

The second display 180b and the third display 180c may be combined with a touch input unit to achieve a touch screen.

Next, the audio output unit 185 may audibly output a message for explaining the function of the vehicle display apparatus 100 and checking whether the driving assistance function is performed. That is, the vehicle display apparatus 100 may provide explanation of the function of the vehicle display apparatus 100 via visual display of the display unit 180 and audio output of the audio output unit 185.

Next, the haptic output unit may output an alarm for the driving assistance function in a haptic manner. For example, the vehicle display apparatus 100 may output vibration to the user when a warning is included in at least one of navigation information, traffic information, communication information, vehicle state information, advanced driver assistance system (ADAS) function and other driver convenience information.

The haptic output unit may provide directional vibration. For example, the haptic output unit may be provided in a steering apparatus for controlling steering to output vibration. Left or right vibration may be output according to the left and right sides of the steering apparatus to enable directional haptic output.

In addition, the power supply unit 190 may receive power and supply power necessary for operation of the components under control of the processor 170.

Lastly, the vehicle display apparatus 100 may include the processor 170 for controlling overall operation of the units of the vehicle display apparatus 100.

In addition, the processor 170 may control at least some of the components described with reference to FIG. 3 in order to execute the application program.

Further, the processor 170 may operate by combining at least two of the components included in the vehicle display apparatus 100, in order to execute the application program.

The processor 170 may be implemented in a hardware manner using at least one selected from among Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, microcontrollers, microprocessors, and electric units for the implementation of other functions.

The processor 170 may control overall operation of the vehicle display apparatus 100 in addition to operation related to the application programs stored in the memory 140. The processor 170 may process signals, data, information, etc. via the above-described components or execute the application programs stored in the memory 140 to provide appropriate information or functions to the user.

The control device 100 may include a cradle 210. The cradle 210 may be installed inside the vehicle 700. The control device 100 may include a power transmitting unit 210, a sensing unit 230, and a button unit 240. The power transmitting unit 210, the sensing unit 230, and the button unit 240 may be included in the cradle 210.

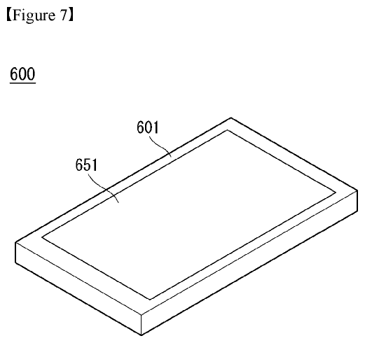

Referring to FIG. 7, the body 601 may form an appearance of the mobile terminal. The display unit 651 may be positioned on one surface of the body 601.

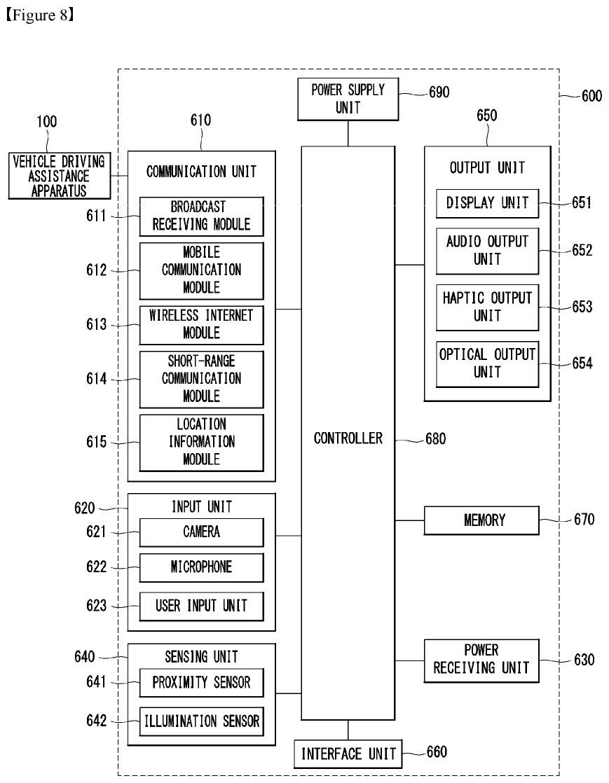

Referring to FIG. 8, the mobile terminal 600 may include a wireless communication unit 610, an input unit 620, a sensing unit 640, an output unit 650, an interface unit 660, a memory 670, a controller 680, and a power supply unit 690. It is understood that implementing all of the illustrated components illustrated in FIG. 8 is not a requirement, and the mobile terminal described in this disclosure may have greater or fewer components.

The wireless communication unit 610 typically includes one or more modules which allow communications such as wireless communications between the mobile terminal 600 and a wireless communication system, communications between the mobile terminal 600 and another mobile terminal, or communications between the mobile terminal 600 and an external server. Further, the wireless communication unit 610 may include one or more modules which connect the mobile terminal 600 to one or more networks.

The wireless communication unit 610 includes one or more of a broadcast receiving module 611, a mobile communication module 612, a wireless Internet module 613, a short-range communication module 614, and a location information module 615.

The input unit 620 may include a camera 621 for inputting an image signal, a microphone 622 or an audio input unit for inputting an audio signal, and a user input unit 623 (for example, a touch key, a mechanical key, etc.) for allowing a user to input information. Voice data or image data collected by the input unit 620 and may be analyzed and processed as a control command of a user.

The user input unit 623 may generate input data according to a command applied from a user. The user input unit 623 may include a key pad, a dome switch, a touch pad, a jog wheel, a jog switch, and the like.

The sensing unit 640 may include one or more sensors configured to sense internal information of the mobile terminal, the surrounding environment of the mobile terminal, and user information. The sensing unit 640 may include at least one of a proximity sensor 641 and an illumination sensor 642, a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an photosensor (for example, camera 621), a microphone 622, a battery gauge, an environment sensor (for example, a barometer, a hygrometer, a thermometer, a radiation detection sensor, a thermal sensor, and a gas sensor, etc.), and a chemical sensor (for example, an electronic nose, a health care sensor, a biometric sensor, etc.). The mobile terminal 600 disclosed in this disclosure may combine and utilize information sensed by at least two of the sensors.

The output unit 650 serves to generate an output related to visual, auditory or tactile sense and includes at least one of a display unit 651, an audio output unit 652, a haptic module 653, and a light output unit 654. The display unit 651 may have an inter-layer structure with a touch sensor or may be integrally formed to realize a touch screen. The touch screen serves as a user input unit 623 that provides an input interface between the mobile terminal 600 and a user and may provide an output interface between the mobile terminal 600 and the user.

The display unit 651 may include a display module 655 for displaying (outputting) information processed in the mobile terminal 600. For example, the display unit 651 may display execution screen information of an application program driven in the mobile terminal 600 or user interface (UI) and graphic user interface (GUI) information according to the execution screen information.

There may be two or more display units 651 according to implementation of the mobile terminal 600. In this case, in the mobile terminal 600, a plurality of display portions may be spaced apart from one another or may be integrally disposed on one surface or may be disposed on different surfaces.

The display unit 651 may include a touch sensor that senses a touch applied to the display unit 651 so that a control command may be received by a touch method. When a touch is applied to the display unit 651, the touch sensor senses the touch, based on which the controller 680 may generate a control command corresponding to the touch. The contents input by the touch method may be a letter or a number, an instruction in various modes, a menu item which may be designated, and the like.

The touch sensor may be configured as a film having a touch pattern and disposed between a window 656 and a display module 655 located on the rear of the window 656 or may be a metal wire directly patterned on the rear surface of the window 656. Alternatively, the touch sensor may be formed integrally with the display module 655. For example, the touch sensor may be disposed on a substrate of the display module 655 or inside the display module 655.

As described above, the display unit 651 may form a touch screen together with the touch sensor, and in this case, the touch screen may serve as a user input unit 623.

The display module 655 may include at least one of a liquid crystal display (LCD), a thin film transistor-liquid crystal display (TFT LCD), an organic light emitting diode (OLED), a flexible display, a 3D display, and an e-ink display.

The display unit 651 may further include the window 656 for viewing the screen of the display module 655 from the outside and protecting the display module 655.

The interface unit 660 serves as an interface with various types of external devices that can be connected to the mobile terminal 600. The interface unit 660 may include at least one of wired/wireless headset ports, external power supply ports, wired/wireless data ports, memory card ports, ports for connecting a device having an identification module, audio input/output (I/O) ports, video I/O ports, earphone ports, and the like. When an external device is connected to the interface unit 660, the mobile terminal 600 may perform appropriate control in relation to the connected external device.

The memory 670 stores data supporting various functions of the mobile terminal 600. The memory 670 may store a plurality of application programs or applications that are driven in the mobile terminal 600, data for operation of the mobile terminal 600, and commands. At least some of these applications may be downloaded from an external server via wireless communication. At least a part of these application programs may exist on the mobile terminal 600 when the mobile terminal 600 was released from the factory for basic functions (e.g., call incoming, outgoing, message reception, and call origination functions) of the mobile terminal 600. Meanwhile, the application program may be stored in the memory 670, installed on the mobile terminal 600, and may be driven by the controller 680 to perform the operation (or function) of the mobile terminal.

In addition to the operations related to the application program, the controller 680 typically controls the overall operation of the mobile terminal 600. The controller 680 may process or process signals, data, information, and the like, input or output through the components described above or may drive an application program stored in the memory 670 to provide or process appropriate information or functions to the user.

The power supply unit 690 can be configured to receive external power or provide internal power in order to supply appropriate power required for operating elements and components included in the mobile terminal 600. The power supply unit 690 may include a battery, and the battery may be configured to be embedded in the terminal body, or configured to be detachable from the terminal body.

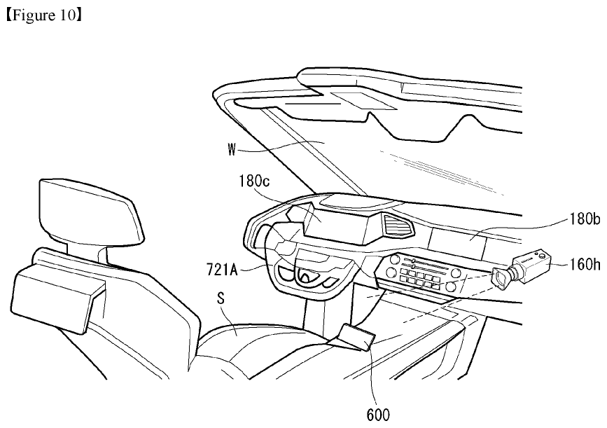

The controller 680 may control at least some of the components shown in FIG. 10 to drive an application program stored in the memory 670. In addition, the controller 680 may operate at least two of the components included in the mobile terminal 600 in combination with each other to drive an application program.

The power supply unit 690 supplies power to the components included in the mobile terminal 600 under the control of the controller 680 upon receiving external power and internal power. The power supply unit 690 may include a battery, and the battery may be an internal battery or a replaceable battery.

At least some of the components may operate in cooperation with each other to implement an operation, control, or a control method of the mobile terminal according to various embodiments described below. In addition, the operation, control, or control method of the mobile terminal may be implemented on the mobile terminal by driving at least one application program stored in the memory 670.

The mobile terminal 600 may include a power receiving unit 630. The power receiving unit 630 may receive power from a power transmitting unit 220 wirelessly. The controller 680 may store the power received by the power receiving unit 630 in the power supply unit 690.

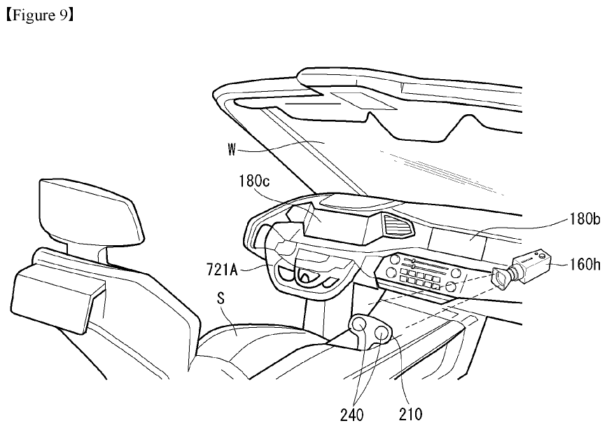

Referring to FIG. 9, the cradle 210 may be installed inside the vehicle 700. The cradle 210 may be located on one side of the driver's seat S. Alternatively, the cradle 210 may be positioned between the driver's seat S and a passenger's seat. The camera 160h may image the inside of the vehicle 700. Alternatively, the camera 160h may image the surrounding of the driver's seat S, the surrounding of the cradle 210, and the surrounding of the passenger's seat. The cradle 210 may include a button unit 240. The cradle 210 may be referred to as a wireless charger 210, a wireless charging module 210, a dock 210, or a station 210. The button unit 240 may be referred to as a button 240.

Referring to FIG. 10, the mobile terminal 600 may be mounted on, seated on, in contact with, or fixed to the cradle 210. The camera 160h may detect that the mobile terminal 600 is mounted on the cradle 210, seated on the cradle 210, in contact with the cradle 210, or fixed to the cradle 210. The mobile terminal 600 may cover the button 240 of the cradle 210.

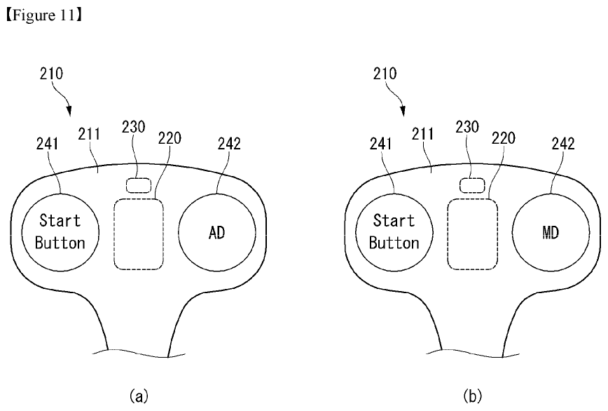

Referring to FIG. 11, the cradle 210 may include a seating surface 211. When the mobile terminal 600 is mounted on the cradle 210, the mobile terminal 600 may be brought into contact with the seating surface 211. Buttons 240, 241, and 242 may be formed on the seating surface 211. The buttons 240, 241, and 242 may be buttons that are displayed as physical buttons or images. The buttons 240, 241, and 242 may be switches for activating a control function of the vehicle 700. For example, the button 241 may turn on and off the start of the vehicle 700. For example, the button 241 may perform a control function to switch a driving mode of the vehicle 700 to an autonomous driving mode or a manual driving mode. When the button 242 indicates “AD”, the driving mode of the vehicle 700 may be the manual driving mode, and when the button 242 indicates “MD”, the driving mode of the vehicle 700 is the automatic driving mode.

The cradle 210 may include the sensing unit 230 and the power transmitting unit 220. The sensing unit 230 may be a sensor for sensing the mobile terminal 600 mounted on, seated on, in contact with, or fixed to the cradle 210. For example, the sensing unit 230 may be at least one of a contact sensor, a pressure sensor, an photosensor, and a near field sensor. The sensing unit 230 may be positioned between the buttons 240, 241, and 242. The power transmitting unit 220 may be located between the buttons 240, 241, and 242.

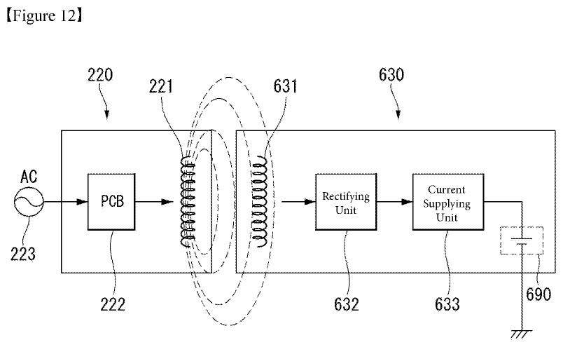

Referring to FIG. 12, the power transmitting unit 220 of the control device 100 may transmit power to the power receiving unit 630 of the mobile terminal 600 wirelessly.

The power transmitting unit 220 may include a coil 221, a printed circuit board (PCB) 222, and an AC power source 400. The coil 221 may be referred to as a primary coil 221. The power receiving unit 630 of the mobile terminal 600 may include a coil 631, a rectifying unit 632, a current supplying unit 633, and a battery 690. The coil 631 may be referred to as a secondary coil 631.

The PCB 222 may receive power from the AC power source 400 and may output a high frequency pulse through a switching operation. The high frequency pulse output from the PCB 222 may be applied to the primary coil 221. The primary coil 221 may form a magnetic field when the high frequency pulse is applied thereto.

The secondary coil 631 may generate an alternating current (AC) from a magnetic field generated by the primary coil 221 of the power transmitting unit 220. Due to the magnetic field generated in the primary coil 221, a high frequency AC may be induced according to linkage of the magnetic field of the secondary coil 631. The rectifying unit 632 may convert the AC generated in the secondary coil 631 into a direct current (DC). The current supply unit 633 may supply the DC current rectified by the rectifying unit 632 to the battery 690. The battery 690 may charge the supplied power. The charging method described above may be applied to resonance magnetic coupling, as well as to inductive coupling.

When the mobile terminal 600 is mounted on, seated on, in contact with or fixed to the cradle 210, wireless charging may be performed. The primary coil 221 may have a very small size, and thus, the size of the power transmitting unit 220 may be reduced. Thus, the power transmitting unit 220 may be located between the buttons 241 and 242 due to the reduced size.

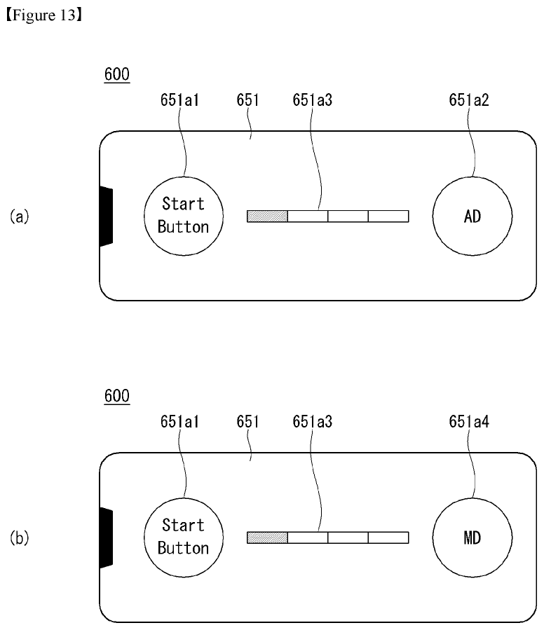

Referring to FIG. 13, when the mobile terminal 600 is mounted on, seated on, in contact with or fixed to the cradle 210 in a transverse direction, the display unit 651 may display images 651a1, 651a2, 651a3, and 651a4. The processor 170 may control display unit 651 to display the images 651a1, 651a2, 651a3, and 651a4. The display unit 651 may display the buttons 240, 241, and 242 of the cradle 210 as the image buttons 651a1 and 651a2. The button 241 may be displayed as the image 651a1. The button 242 may be displayed as the images 651a2 and 651a4. The display unit 651 may display an image 651a3 indicating a charge state or a charged amount. information exchange between the processor 170 and the mobile terminal 600 may use a short-range communication method.

The mobile terminal 600 may receive an input from the occupant for the image buttons 651a1, 651a2, and 651a4. The mobile terminal 600 may transmit the received information to the processor 170. When the input information is received from the mobile terminal 600, the processor 170 may activate control functions of the buttons 240, 241, and 242 corresponding to the image buttons 651a1, 651a2, and 651a4. For example, when the occupant touches the image button 651a1, the processor 170 may start the vehicle 700. Alternatively, when the occupant touches the image button 651a2, the processor 170 may change the driving mode of the vehicle 700 to the autonomous driving mode. Alternatively, when the occupant touches the image button 651a4, the processor 170 may change the driving mode of the vehicle 700 to the manual driving mode.

The processor 170 may deactivate the buttons 240, 241, and 242 when the mobile terminal 600 is mounted on, seated on, in contact with or fixed to the cradle 210 in the transverse direction. Accordingly, even if the buttons 240, 241, and 242 are pressed by the mobile terminal 600, the control functions of the buttons 240, 241, and 242 may not be performed.

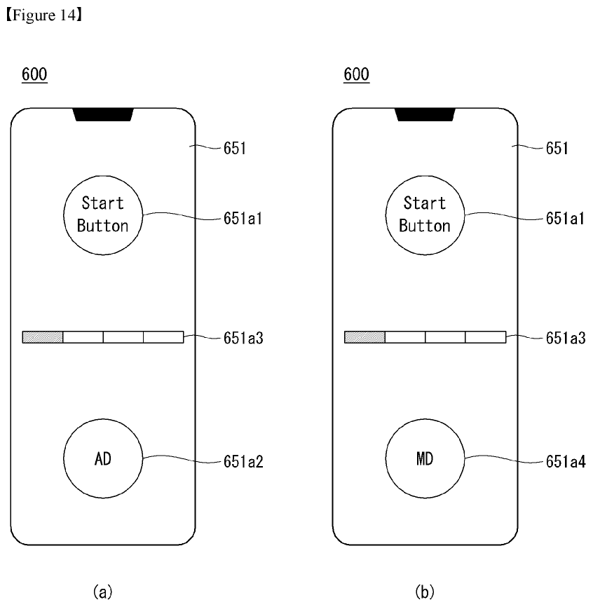

Referring to FIG. 14, when the mobile terminal 600 is mounted on, seated on, in contact with or fixed to the cradle 210 in a longitudinal direction, the display unit 651 may display images 651a1, 651a2, 651a3, and 651a4. The processor 170 may control display unit 651 to display images 651a1, 651a2, 651a3, and 651a4. The display unit 651 may display the buttons 240, 241, and 242 of the cradle 210 as image buttons 651a1 and 651a2. The button 241 may be displayed as the image 651a1. The button 242 may be displayed as the images 651a2 and 651a4. The display unit 651 may display an image 651a3 indicating a charge state or a charged amount. Information exchange between the processor 170 and the mobile terminal 600 may utilize a short-range communication method.

The mobile terminal 600 may receive an input from the occupant for the image buttons 651a1, 651a2, and 651a4. The mobile terminal 600 may transmit the received information to the processor 170. When the input information is received from the mobile terminal 600, the processor 170 may activate control functions of the buttons 240, 241, and 242 corresponding to the image buttons 651a1, 651a2, and 651a4. For example, when the occupant touches the image button 651a1, the processor 170 may start the vehicle 700. Alternatively, when the occupant touches the image button 651a2, the processor 170 may change the driving mode of the vehicle 700 to the autonomous driving mode. Alternatively, when the occupant touches the image button 651a4, the processor 170 may change the driving mode of the vehicle 700 to the manual driving mode.

The processor 170 may deactivate the buttons 240, 241, and 242 when the mobile terminal 600 is mounted on, seated on, in contact with or fixed to the cradle 210 in the transverse direction. Accordingly, even if the buttons 240, 241, and 242 are pressed by the mobile terminal 600, the control functions of the buttons 240, 241, and 242 may not be performed.

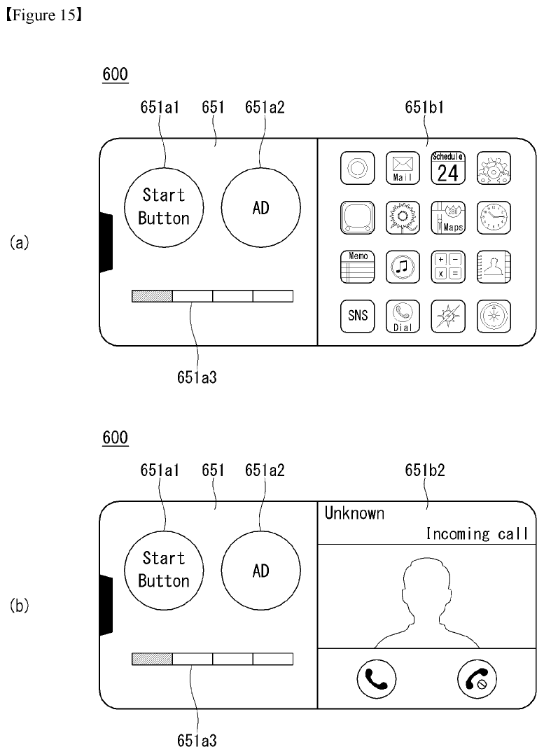

Referring to FIG. 15, when the mobile terminal 600 is mounted on, seated on, in contact with or fixed to the cradle 210 in the transverse direction 210, the display unit 651 may display images 651a1, 651a2, and 651a3, and the contents 651b1 and 651b2 of the mobile terminal 600. The processor 170 may control the display unit 651 to display the images 651a1, 651a2, 651a3, and 651a4 and the contents 651b1 and 651b2 of the mobile terminal 600. The contents 651b1 and 651b2 may be programs or applications stored in the mobile terminal 600 in advance. Accordingly, the user may utilize the function of the mobile terminal 600 even if the mobile terminal 600 is mounted on, seated on, in contact with or fixed to the cradle 210. For example, the user may transmit and receive a telephone call using the mobile terminal 600.

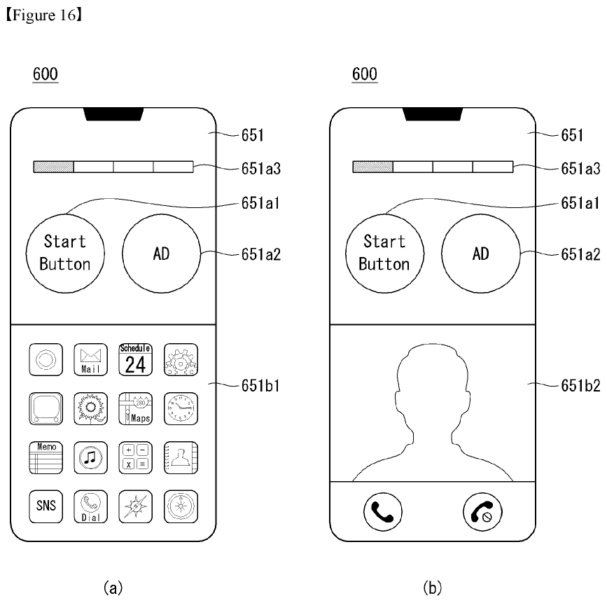

Referring to FIG. 16, when the mobile terminal 600 is mounted on, seated on, in contact with or fixed to the cradle 210 in the transverse direction 210, the display unit 651 may display images 651a1, 651a2, and 651a3, and the contents 651b1 and 651b2 of the mobile terminal 600. The processor 170 may control the display unit 651 to display the images 651a1, 651a2, 651a3, and 651a4 and the contents 651b1 and 651b2 of the mobile terminal 600. The contents 651b1 and 651b2 may be programs or applications stored in the mobile terminal 600 in advance. Accordingly, the user may utilize the function of the mobile terminal 600 even if the mobile terminal 600 is mounted on, seated on, in contact with or fixed to the cradle 210. For example, the occupant may transmit and receive a call using the mobile terminal 600.

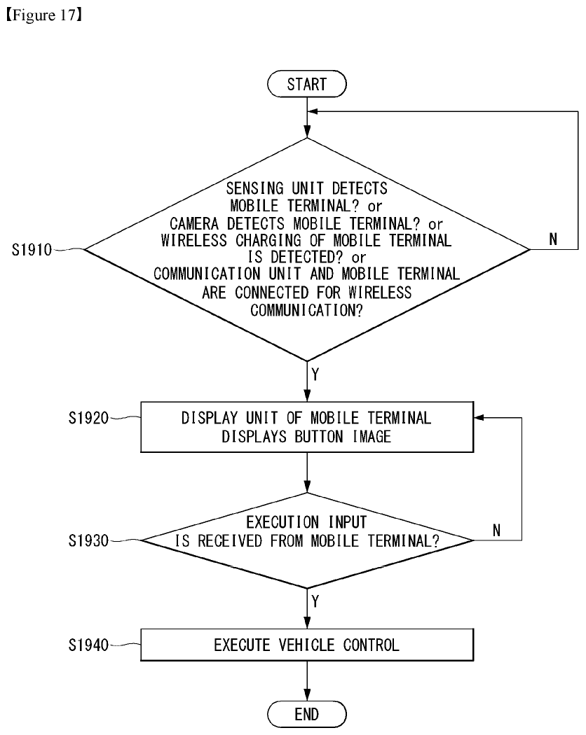

Referring to FIG. 17, the processor 170 may detect that the mobile terminal 600 is mounted on, seated on, in contact with or fixed to the cradle 210 through the sensing unit 230. Alternatively, the processor 170 may detect that the mobile terminal 600 is mounted on, seated on, in contact with or fixed to the cradle 210 through the internal camera 160h of the vehicle 700. Alternatively, the processor 170 may detect that power is transmitted to the mobile terminal 600 through the power transmitting unit 220. Alternatively, the processor 170 may detect that wireless communication is established with the mobile terminal 600 through the communication unit 120 (S1910).

When the mobile terminal 600 is detected through the sensing unit 230 or the camera 160h, when wireless charging of the mobile terminal 600 is detected, or when connection to the mobile terminal 600 through the communication unit 120 is detected, the processor may control the display unit 610 of the mobile terminal 600 to display the button images 651a1, 651a2, and 651a4 (S1920).

The processor 170 may receive the occupant's input regarding the button images 651a1, 651a2, and 651a4 from the mobile terminal 600 through the communication unit 120 (S1930).

When the occupant's input regarding the button images 651a1, 651a2, and 651a4 is received from the mobile terminal 600 through the communication unit 120, the processor 170 may execute the control functions of the buttons 240, 241, and 242 corresponding to the button images 651a1, 651a2, and 651a4 (S1940).

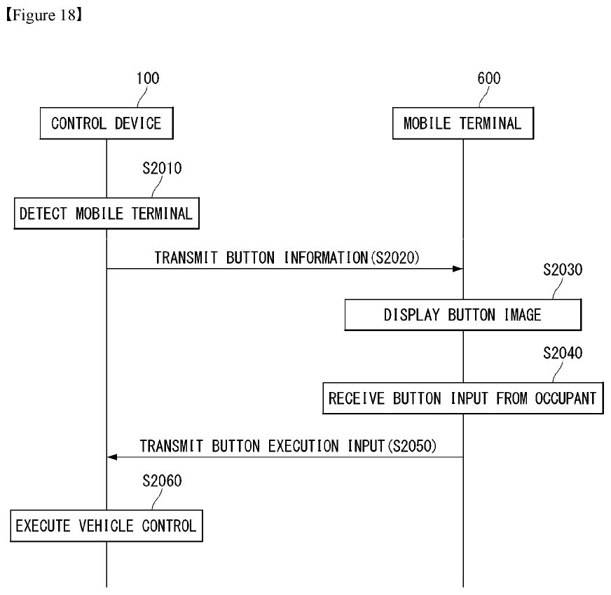

Referring to FIG. 18, the processor 170 of the control device 100 may detect the mobile terminal 600 (S2010). When the mobile terminal 600 is detected, the processor 170 may transmit information on the buttons 240, 241, and 242 (S2020). The mobile terminal 600 may display button images 651a1, 651a2, and 651a4 regarding the buttons 240, 241, and 242 (S2030). The mobile terminal 600 may receive execution inputs for the button images 651a1, 651a2, and 651a4 from the occupant (S2040). The mobile terminal 600 may send the execution inputs regarding the button images 651a1, 651a2, and 651a4 to the processor 170 (S2050). The processor 170 may control the vehicle 700 according to the received information (S2060).

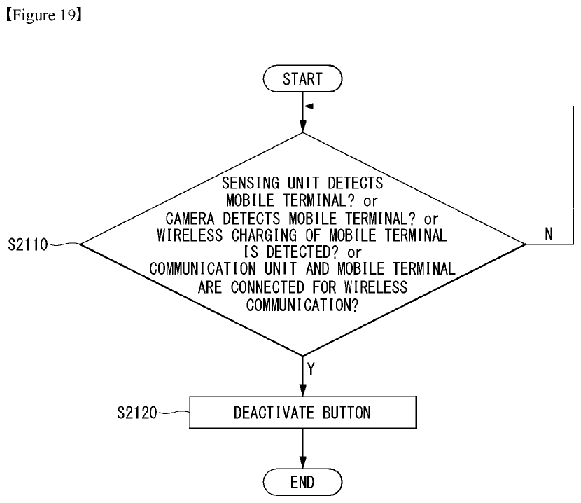

Referring to FIG. 19, the processor 170 may detect that the mobile terminal 600 is mounted on, seated on, in contact with or fixed to the cradle 210 through the sensing unit 230. Alternatively, the processor 170 may detect that the mobile terminal 600 is mounted on, seated on, in contact with or fixed to the cradle 210 through the internal camera 160h of the vehicle 700. Alternatively, the processor 170 may detect that power is transmitted to the mobile terminal 600 through the power transmitting unit 220. Alternatively, the processor 170 may detect that wireless communication is established with the mobile terminal 600 through the communication unit 120 (S2110).

When the mobile terminal 600 is detected through the sensing unit 230 or the camera 160h, when wireless charging of the mobile terminal 600 is detected, or when connection to the mobile terminal 600 through the communication unit 120 is detected, the processor may deactivate the buttons 240, 241, and 242.

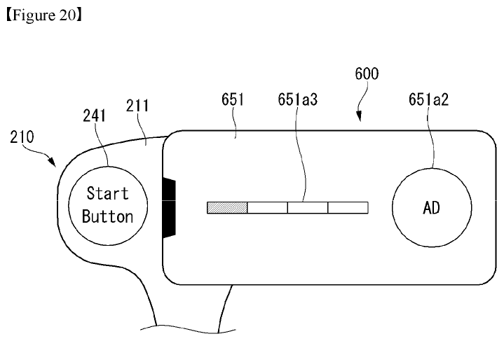

Referring to FIG. 20, when the mobile terminal 600 is mounted on, seated on, in contact with or fixed to the cradle 210 in the transverse direction 210, the button 242 may be covered by the mobile terminal 600 and the button 241 may not be covered by the mobile terminal 600. The processor 170 may control the display unit 610 to display the image 651a2 for the button 242 covered by the mobile terminal 600. The processor 170 may also control the display unit 651 not to display the button 241 not covered by the mobile terminal 600. The processor 170 may deactivate the button 242 covered by the mobile terminal 600. Accordingly, even if the buttons 240, 241, and 242 are pressed by the mobile terminal 600, the control functions of the buttons 240, 241, and 242 may not be executed.

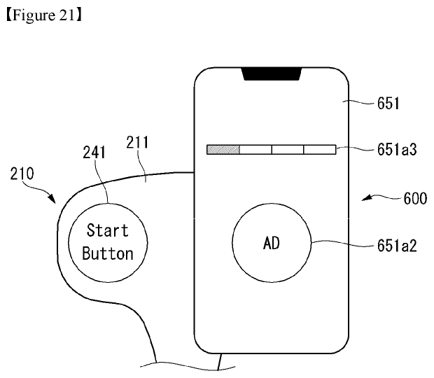

Referring to FIG. 21, when the mobile terminal 600 is mounted on, seated on, in contact with or fixed to the cradle 210 in the transverse direction 210, the button 242 may be covered by the mobile terminal 600 and the button 241 may not be covered by the mobile terminal 600. The processor 170 may control the display unit 610 to display the image 651a2 for the button 242 covered by the mobile terminal 600. The processor 170 may also control the display unit 651 not to display the button 241 not covered by the mobile terminal 600. The processor 170 may deactivate the button 242 covered by the mobile terminal 600. Accordingly, even if the buttons 240, 241, and 242 are pressed by the mobile terminal 600, the control functions of the buttons 240, 241, and 242 may not be executed.

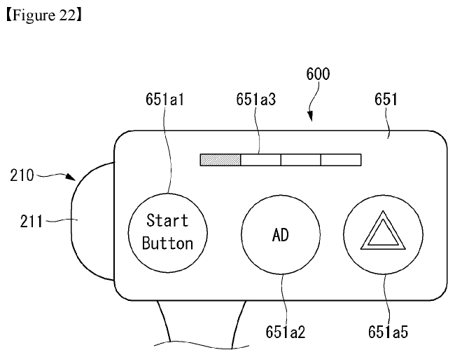

Referring to FIG. 22, the mobile terminal may have a very large size as compared with the cradle. Accordingly, when the mobile terminal 600 is mounted on, seated on, in contact with or fixed to the cradle 210, the mobile terminal 600 may cover the buttons 240, 241, and 242 of the cradle 210 and a button (not shown) adjacent to the cradle 210. Here, the processor 170 may control the display unit 651 to display buttons that are adjacent to the cradle 210 and that are covered by the mobile terminal 600. The mobile terminal 600 may receive an input regarding the image button 651a5 from the occupant. The mobile terminal 600 may transmit the received information to the processor 170. Upon receiving the input information from the mobile terminal 600, the processor 170 may activate the control function of the button corresponding to the image button 651a5. For example, when the occupant touches the image button 651a5, the processor 170 may turn on/off an emergency light of the vehicle 700.

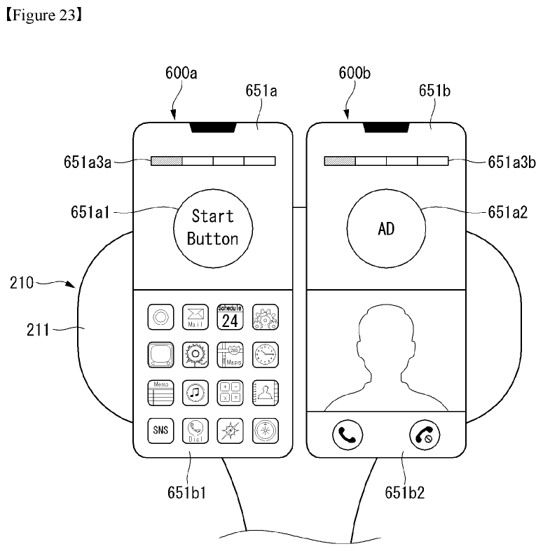

Referring to FIG. 23, when the cradle 210 is sufficiently large, a plurality of mobile terminals 600 may be mounted on the cradle 210. When the mobile terminal 600a is mounted on, seated on, in contact with or fixed to the cradle 210 in the longitudinal direction, the processor 170 may control the display unit 651a to display the images 651a1a and 651a3a and contents 651b1 of a mobile terminal 600a.

When a mobile terminal 600b is mounted on, seated on, in contact with or fixed to the cradle 210 in the longitudinal direction, the processor 170 may control the display unit 651b to display the images 651a2 and 651a3b and content 651b2 of the mobile terminal 600b.

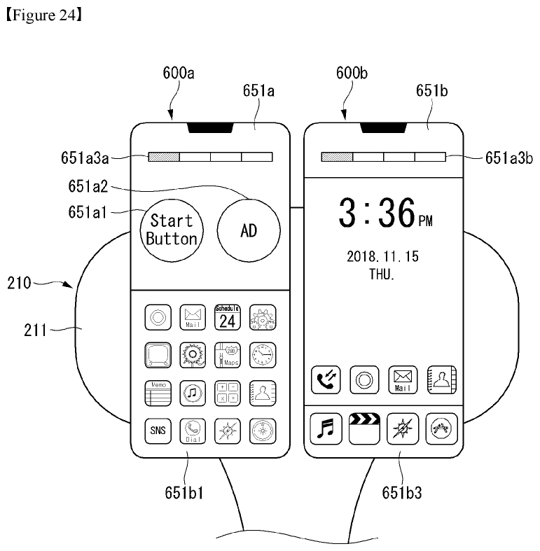

Referring to FIG. 24, when the cradle 210 is sufficiently large, a plurality of mobile terminals 600 may be mounted on the cradle 210. When the mobile terminal 600a is mounted on, seated on, in contact with or fixed to the cradle 210 in the longitudinal direction, the processor 170 may control the display unit 651a to display the images 651a1a, 651a2, and 651a3a and contents 651b1 of a mobile terminal 600a.

When a mobile terminal 600b is mounted on, seated on, in contact with or fixed to the cradle 210 in the longitudinal direction, the processor 170 may control the display unit 651b to display the image 651a3b and content 651b3 of the mobile terminal 600b.

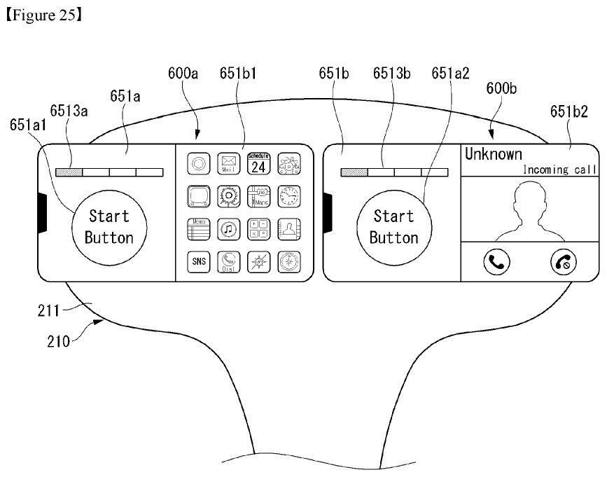

Referring to FIG. 25, when the cradle 210 is sufficiently large, a plurality of mobile terminals 600 may be mounted on the cradle 210. When the mobile terminal 600a is mounted on, seated on, in contact with or fixed to the cradle 210 in the transverse direction, the processor 170 may control the display unit 651a to display the images 651a1 and 651a3a and contents 651b1 of a mobile terminal 600a.

When a mobile terminal 600b is mounted on, seated on, in contact with or fixed to the cradle 210 in the transverse direction, the processor 170 may control the display unit 651b to display the image 651a2 and 651a3b and content 651b2 of the mobile terminal 600b.

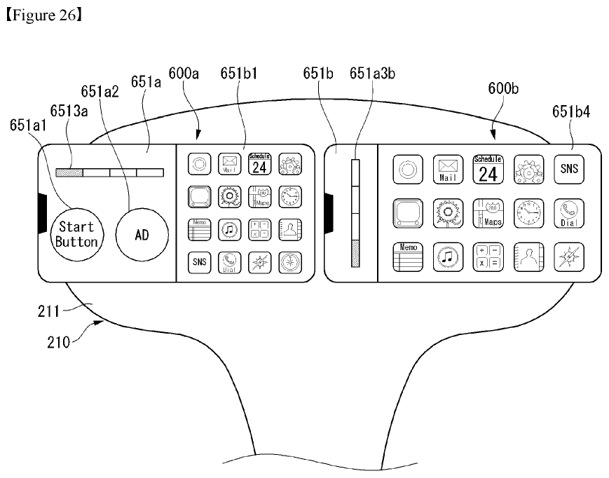

Referring to FIG. 26, when the cradle 210 is sufficiently large, a plurality of mobile terminals 600 may be mounted on the cradle 210. When the mobile terminal 600a is mounted on, seated on, in contact with or fixed to the cradle 210 in the transverse direction, the processor 170 may control the display unit 651a to display the images 651a1, 651a2, and 651a3a and content 651b1 of a mobile terminal 600a.

When a mobile terminal 600b is mounted on, seated on, in contact with or fixed to the cradle 210 in the transverse direction, the processor 170 may control the display unit 651b to display the image 651a3b and content 651b4 of the mobile terminal 600b.

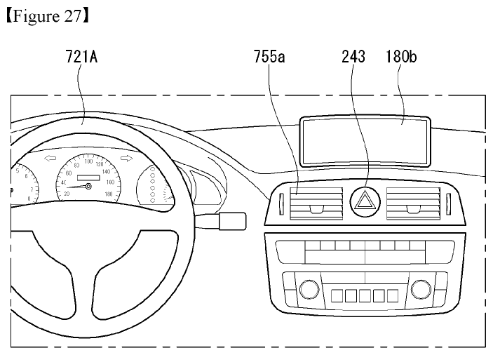

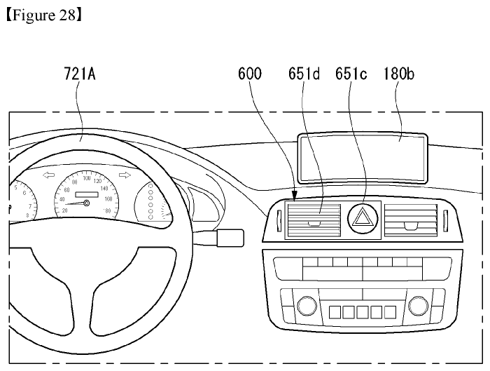

Referring to FIGS. 27 and 28, the mobile terminal 600 may be mounted inside the vehicle 700. The processor 170 may detect the region covered by the mobile terminal 600 through the camera 160h. The processor 170 may detect that the mobile terminal 600 covers an air vent 755a and an emergency light button 243 via the camera 160h. The processor 170 may control the mobile terminal 600 to display an image 651d corresponding to the air vent 755a and a button image 651c corresponding to the emergency light button 243 on the display unit 651. The mobile terminal 600 may transmit an occupant input regarding the button image 651c to the processor 170. The processor 170 may turn on/off the emergency light of the vehicle 700 according to the received information.

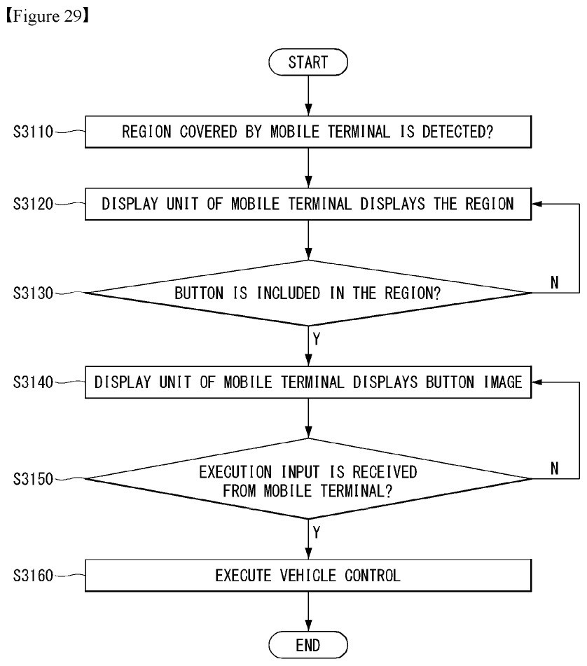

Referring to FIG. 29, when the mobile terminal 600 is mounted inside the vehicle 700, the processor 170 may detect a region covered by the mobile terminal 600 through the camera 160h (S3110). The processor 170 may control the display unit 651 to display the region covered by the mobile terminal 600 (S3120). The processor 170 may determine whether a button is included in the region covered by the mobile terminal 600 (S3130). When it is determined that the button is included in the region covered by the mobile terminal 600, the processor 170 may control the display unit 651 to display an image button (S3140). The processor 170 may determine whether an execution input regarding the image button is received from the mobile terminal 600. When the execution input of the image button is received from the mobile terminal 600, the processor 170 may execute a control function of the button corresponding to the image button to control the vehicle (S3160).

Embodiment 1: A control device includes: a communication unit wirelessly exchanging information with a mobile terminal; a cradle installed in a vehicle and including a seating surface and a button formed on the seating surface; a sensing unit sensing an object in contact with the seating surface; and a processor transmitting information on the button to the mobile terminal through the communication unit to control a display unit of the mobile terminal to display a button image corresponding to the button if the mobile terminal is detected through the sensing unit.

Embodiment 2: The control device in Embodiment 1, in which the button turns on or off a control function of the vehicle, and the processor executes the control function if the mobile terminal is detected through the sensing unit and an execution command of the control function is received through the communication unit.

Embodiment 3: The control device in Embodiment 1 or 2, in which the processor deactivates the button if the mobile terminal is detected through the sensing unit.

Embodiment 4: The control device in Embodiment 1, in which the cradle further includes a power transmitting unit adjacent to the button and transmitting power wirelessly.

Embodiment 6: The control device in Embodiment 4, in which the processor controls the display unit to further display an indicator indicative of a charged amount.

Embodiment 7: The control device in Embodiment 4, in which the processor receives the charged amount of the mobile terminal through the communication unit, and when the charged amount is equal to or greater than a reference value, the processor receives content of the mobile terminal through the communication unit and control a display inside the vehicle to display the content.

Embodiment 8: The control device in Embodiment 1, in which the sensing unit is installed on the seating surface and include at least one of a contact sensor, a pressure sensor, and a photosensor.

Embodiment 9: The control device in Embodiment 1, in which if the mobile terminal is detected through the sensing unit, the processor controls the display unit to display the button image in a first region of the display unit and to display content of the mobile terminal in a second region of the display unit.

Embodiment 10: The control device in Embodiment 1, in which when detection of the mobile terminal is stopped after the mobile terminal is detected through the sensing unit, the processor transmits information on the button to the mobile terminal through the communication unit so that the display unit of the mobile terminal displays a button image corresponding to the button.

Embodiment 11: The control device in Embodiment 1, in which the sensing unit includes a camera installed inside the vehicle and imaging the seating surface.

Embodiment 12: The control device in Embodiment 10, in which the button includes a first button and a second button, and when the mobile terminal is detected through the camera, the processor identifies the first button covered by the mobile terminal through the camera and transmit information on the first button to the mobile terminal through the communication unit so that the display unit displays a button image corresponding to the first button.

Embodiment 12: The control device in Embodiment 11, in which the processor identifies the second button not covered by the mobile terminal through the camera and transmits information on the second button to the mobile terminal through the communication unit so that the display unit displays a button image corresponding to the second button.

Embodiment 13: The control device in Embodiment 10, in which the communication unit wirelessly exchanges information with a first mobile terminal and a second mobile terminal, the button includes a first button and a second button, and when the first mobile terminal and the second mobile terminal in contact with the seating surface are detected through the camera, the processor identifies the first button covered by the first mobile terminal and the second button covered by the second mobile terminal through the camera and controls a display unit of the first mobile terminal to display a button image corresponding to the first button through the communication unit and control a display unit of the second mobile terminal to display a button image corresponding to the second button through the communication unit.

Embodiment 14: The control device in Embodiment 10, in which the communication unit wirelessly exchanges information with a first mobile terminal and a second mobile terminal, the button includes a first button and a second button, and when the first mobile terminal and the second mobile terminal in contact with the seating surface are detected through the camera, the processor identifies the first button covered by the first mobile terminal and the second button covered by the second mobile terminal through the camera and controls a display unit of the first mobile terminal to display a button image corresponding to the first button and a button image corresponding to the second button through the communication unit.

Embodiment 15: The control device in Embodiment 10, in which the processor detects a region which is covered by the mobile terminal and adjacent to the cradle through the camera, and controls the display unit of the mobile terminal to display the region through the communication unit.

Embodiment 16: The control device in Embodiment 15, in which when a third button is identified in the region through the camera, the processor controls the display unit of the mobile terminal to display a button image corresponding to the third button through the communication unit.

Embodiment 21: A control method includes: sensing a mobile terminal in contact with a seating surface of a cradle inside a vehicle; transmitting, to the mobile terminal, information on a button formed on the seating surface and turning on or off a function of controlling the vehicle if the mobile terminal is detected; receiving an execution command of the function from the mobile terminal; and executing the function when the execution command is received.

Embodiment 22: The control method in Embodiment 21, in which the transmitting of information on the button to the mobile terminal includes instructing the mobile terminal so that a display unit of the mobile terminal displays a button image corresponding to the button.

Embodiment 23: The control method in Embodiment 21, further includes: deactivating the button if the mobile terminal is detected.

Embodiment 24: The control method in Embodiment 21, further includes:

wirelessly transmitting power to the mobile terminal through a power transmitting unit adjacent to the button.

Embodiment 25: The control method in Embodiment 24, further includes: transmitting a command to the mobile terminal so that the display unit of the mobile terminal displays an indicator indicative of a charged amount.

Embodiment 26: The control method in Embodiment 24, further includes: receiving the charged amount of the mobile terminal from the mobile terminal; and transmitting a command to the mobile terminal to display content of the mobile terminal on a display unit of the vehicle if the charged amount is equal to or greater than a reference value.

Embodiment 27: The control method in Embodiment 21, in which the detecting of the mobile terminal is performed through at least one of a contact sensor, a pressure sensor, and an photosensor provided on the seating surface.

Embodiment 28: The control method in Embodiment 22, further includes: transmitting a command to the mobile terminal so that a button image is displayed in a first region of the display unit; and transmitting a command to the mobile terminal so that content of the mobile terminal is displayed in a second region of the display unit.

Embodiment 29: The control method in Embodiment 21, in which the detecting of the mobile terminal includes detecting through a camera that images the seating surface.

Embodiment 30: The control method in Embodiment 29, further includes: detecting a region which is covered by the mobile terminal through the camera and adjacent to the cradle; and transmitting a command to the mobile terminal so that the display unit of the mobile terminal displays the region.

Embodiment 31: The control method in Embodiment 20, further includes:

identifying a fourth button in the region through the camera; and transmitting a command to the mobile terminal so that the display unit of the mobile terminal displays a button image corresponding to the fourth button if the fourth button is identified.

Embodiment 41: A mobile terminal includes: a display unit displaying an image; a communication unit exchanging information with a vehicle wirelessly; and a processor controlling the display unit to display a button image corresponding to a button when information on the button is received through the communication unit.

Embodiment 42: The mobile terminal in Embodiment 41, further includes: an input unit receiving an execution command from an occupant, in which the processor transmits the execution command to the vehicle through the communication unit when the execution command of the occupant regarding the button image is received through the input unit.

Embodiment 43: The mobile terminal in Embodiment 41, further includes: a power receiving unit receiving power wirelessly, in which the processor controls the display unit to further display an indicator indicative of a charged amount.

Embodiment 44: The mobile terminal in Embodiment 41, further includes: a memory storing content, in which the processor controls the display unit to display the button image in a first region of the display unit and to display the content in a second region of the display unit.

The effects of the control device according to the present invention are as follows. According to at least one of the embodiments of the present invention, the control device assisting driving of the vehicle can be provided. According to at least one of the embodiments of the present invention, the control device for wirelessly transmitting power to a mobile terminal when the mobile terminal is mounted on a vehicle can be provided. According to at least one embodiment of the present invention, the control device capable of controlling a mobile terminal to display an image button for controlling a vehicle when the mobile terminal is mounted on the vehicle can be provided.

The effects of the control method according to the present invention are as follows. According to at least one of the embodiments of the present invention, a method of assisting driving of a vehicle can be provided. According to at least one embodiment of the present invention, the control method of wirelessly transmitting power to a mobile terminal when the mobile terminal is mounted on a vehicle can be provided. According to at least one of the embodiments of the present invention, the control method of controlling a mobile terminal to display an image button for controlling a vehicle when the mobile terminal is mounted on the vehicle can be provided.

The control device or the control method according to the above-described embodiments may assist the driver in driving. The control device or the control method according to the above-described embodiments may assist the vehicle so that the vehicle may drive autonomously or semi-autonomously.

The above described features, configurations, effects, and the like are included in at least one of the implementations of the present disclosure, and should not be limited to only one implementation. In addition, the features, configurations, effects, and the like as illustrated in each implementation may be implemented with regard to other implementations as they are combined with one another or modified by those skilled in the art. Thus, content related to these combinations and modifications should be construed as being included in the scope of the accompanying claims.

Further, although the implementations have been mainly described until now, they are just exemplary and do not limit the present disclosure. Thus, those skilled in the art will understand that various modifications and applications which have not been exemplified may be carried out within a range which does not deviate from the essential characteristics of the implementations. For instance, the constituent elements described in detail in the exemplary implementations may be modified to be carried out. Further, the differences related to such modifications and applications shall be construed to be included in the scope of the present disclosure specified in the attached claims.

1. A control device comprising:
a communication unit wirelessly exchanging information with a mobile terminal;
a cradle installed in a vehicle and including a seating surface and a button formed on the seating surface;
a sensing unit sensing an object in contact with the seating surface; and
a processor transmitting information on the button to the mobile terminal through the communication unit to control a display unit of the mobile terminal to display a button image corresponding to the button if the mobile terminal is detected through the sensing unit.

2. The control device of claim 1, wherein
the button turns on or off a control function of the vehicle, and
the processor executes the control function if the mobile terminal is detected through the sensing unit and an execution command of the control function is received through the communication unit.

3. The control device of claim 1, wherein
the processor deactivates the button if the mobile terminal is detected through the sensing unit.

4. The control device of claim 1, wherein
the cradle further includes a power transmitting unit adjacent to the button and transmitting power wirelessly.

5. The control device of claim 4, wherein
the processor controls the display unit to further display an indicator indicative of a charged amount.

6. The control device of claim 4, wherein
the processor receives the charged amount of the mobile terminal through the communication unit, and
when the charged amount is equal to or greater than a reference value, the processor receives content of the mobile terminal through the communication unit and control a display inside the vehicle to display the content.

7. The control device of claim 1, wherein
the sensing unit is installed on the seating surface and comprises at least one of a contact sensor, a pressure sensor, and a photosensor.

8. The control device of claim 1, wherein
if the mobile terminal is detected through the sensing unit, the processor controls the display unit to display the button image in a first region of the display unit and to display content of the mobile terminal in a second region of the display unit.

9. The control device of claim 1, wherein
when detection of the mobile terminal is stopped after the mobile terminal is detected through the sensing unit, the processor transmits information on the button to the mobile terminal through the communication unit so that the display unit of the mobile terminal displays a button image corresponding to the button.

10. The control device of claim 1, wherein
the sensing unit includes a camera installed inside the vehicle and imaging the seating surface.

11. The control device of claim 10, wherein
the button includes a first button and a second button, and
when the mobile terminal is detected through the camera, the processor identifies the first button covered by the mobile terminal through the camera and transmits information on the first button to the mobile terminal through the communication unit so that the display unit displays a button image corresponding to the first button.

12. The control device of claim 11, wherein
the processor identifies the second button not covered by the mobile terminal through the camera and transmit information on the second button to the mobile terminal through the communication unit so that the display unit displays a button image corresponding to the second button.

13. The control device of claim 10, wherein
the communication unit wirelessly exchanges information with a first mobile terminal and a second mobile terminal,
the button includes a first button and a second button, and
when the first mobile terminal and the second mobile terminal in contact with the seating surface are detected through the camera,
the processor identifies the first button covered by the first mobile terminal and the second button covered by the second mobile terminal through the camera and control a display unit of the first mobile terminal to display a button image corresponding to the first button through the communication unit and control a display unit of the second mobile terminal to display a button image corresponding to the second button through the communication unit.

14. The control device of claim 10, wherein
the communication unit wirelessly exchanges information with a first mobile terminal and a second mobile terminal, and
the button includes a first button and a second button, and
when the first mobile terminal and the second mobile terminal in contact with the seating surface are detected through the camera, the processor identifies the first button covered by the first mobile terminal and the second button covered by the second mobile terminal through the camera and control a display unit of the first mobile terminal to display a button image corresponding to the first button and a button image corresponding to the second button through the communication unit.

15. The control device of claim 10, wherein
the processor detects a region which is covered by the mobile terminal and adjacent to the cradle through the camera, and controls the display unit of the mobile terminal to display the region through the communication unit.

16. The control device of claim 15, wherein
when a third button is identified in the region through the camera, the processor controls the display unit of the mobile terminal to display a button image corresponding to the third button through the communication unit.

17. A control method comprising:
sensing a mobile terminal in contact with a seating surface of a cradle inside a vehicle;
transmitting, to the mobile terminal, information on a button formed on the seating surface and turning on or off a function of controlling the vehicle if the mobile terminal is detected;
receiving an execution command of the function from the mobile terminal; and
executing the function when the execution command is received.

18. The control method of claim 17, wherein
the transmitting of information on the button to the mobile terminal includes instructing the mobile terminal so that a display unit of the mobile terminal displays a button image corresponding to the button.

19. The control method of claim 17, further comprising:
deactivating the button if the mobile terminal is detected.

20. The control method of claim 17, further comprising:
wirelessly transmitting power to the mobile terminal through a power transmitting unit adjacent to the button.
